(19) United States
(12) Patent Application Publication
(10) Pub. No.: US 2013/0324232 A1
(43) Pub. Date: Dec. 5, 2013

(54) METHODS AND APPARATUS FOR GAMES PERMITTING PAYOUT ALLOCATION TOWARD SAME-ROUND WAGERS

(71) Applicant: SHFL entertainment, Inc., Las Vegas, NV (US)

(72) Inventor: Roger M. Snow, Las Vegas, NV (US)

(21) Appl. No.: 13/843,060

(22) Filed: Mar. 15, 2013

Related U.S. Application Data
(63) Continuation-in-part of application No. 13/483,983, filed on May 30, 2012.
Application No. 13/483,983 is a continuation-in-part of application No. 13/631,630, filed on Sep. 28, 2012.

(51) Int. Cl. G07F 17/32

(52) U.S. Cl. CPC G07F 17/3244
USPC 463/26; 273/292

(57) ABSTRACT

Methods of administering wagering games comprise accepting from a player a primary wager on a primary wagering game and, optionally, a secondary wager on a secondary wagering game. Cards are dealt to a player hand and a banker hand. The secondary wager is resolved, and payouts on the secondary wagering game are allocated to one of the player, the primary wager, and another primary wager in accordance with an instruction directing the allocation. Thus, payouts from one game in a round of wagering may be applied toward another wager in the same round of wagering. The primary wager can then be resolved. Games of the present invention may be implemented as live card games, EGM games, multi-player EGM games, on-line games, scratch ticket games, and on live card games with electronic betting interfaces.

### CROSS-REFERENCE TO RELATED APPLICATION

This application is a continuation-in-part of U.S. patent application Ser. No. 13/483,983, filed May 30, 2012, and a continuation-in-part of U.S. patent application Ser. No. 13/631,630, filed Sep. 28, 2012, which is a continuation-in-part of the aforementioned U.S. patent application Ser. No. 13/483,983, the disclosure of each of which is incorporated herein in its entirety by this reference.

### TECHNICAL FIELD

The disclosure relates generally to methods of administering wagering games for casinos and other gaming establishments and to related systems and apparatuses. More specifically, disclosed embodiments relate to methods of, and systems and apparatuses for, administering wagering games including at least one side wager, a payout from which may be allocated to another wager in the same round of play.

### BACKGROUND

Baccarat is a popular wagering game played in casinos and other gaming establishments. There are a number of variations of the basic game of baccarat, and the game is sometimes referred to in its various forms as Baccarat-Chemin-de-Fer, Baccarat a deux tableaux, Mini-Baccarat, and the like. The rules may vary slightly, and rules may vary from casino to casino, but the underlying game may involve a competition between two hands, usually referred to as the hands of “the banker” and “the player.” All players at the table can place wagers, but only one “player hand” may be dealt. Initially, two cards may be dealt to each of the banker hand and the player hand. The results of the competition are determined by how close the point total (explained in detail below) is to a value of nine. Point totals are based on the added face value of the cards, with the values of the cards being Ace card=1 point, 2 card=2 points, 3 card=3 points, 4 card=4 points, 5 card=5 points, 6 card=6 points, 7 card=7 points, 8 card=8 points, 9 card=9 points, 10 card=10 points, jack card=0 points (or 10 points), queen card=0 points (or 10 points), and king card=0 points (or 10 points). Only the last digit of the sum of the point values of the cards is operative in the play of the game. For example, a total value of the cards (both with the original hand or partial hand) would be read as total of 10 points=0, 11 points=1, 12 points=2, 13 points=3, 14 points=4, 15 points=5, 16 points=6, 17 points=7, 18 points=8, 19 points=9, and 20 points=0, etc. Two-card hands with a point total of eight or nine are “naturals.”

A player participating in wagering on the baccarat game usually has an option to place a wager on the player hand, the banker hand or a tie. (Therefore, the “player hand” is not necessarily specific to the participating, wagering player.) Thus, when a baccarat wager is received, it may be designated for the banker hand, the player hand or a tie. Designating the wager for the designated hand may be accomplished by placing a wager on a designated space for a wager on the banker hand or placing the wager on a designated space for a wager on the player hand. Designating a wager on a tie is accomplished by placing a bet on a tie betting space. A house commission of, e.g., 5%, may be taken from winnings on banker hands.

Some alterations to traditional baccarat have been made, including side bets made while playing baccarat. For example, DRAGON BONUS™ baccarat is a variant of baccarat in which players are permitted to make a side wager. More specifically, players may wager that the banker hand will win or the player hand either will win on a “natural” (i.e., when the initial two cards dealt to the banker, to the player, or both total a score of eight or nine) or will win by at least four points. As another example, EZ BACCARA™ is a variant of baccarat in which players are permitted to make side wagers. More specifically, players may wager that the banker hand will win with a three-card score of seven, a wager called the “Dragon 7,” or that the player hand will win with a three-card score of eight, a wager called the “Panda 8.” In addition to these side bets, EZ BACCARA™ involves no-commission wins both for wagers designated for the player hand and wagers designated for the banker hand. That is, EZ BACCARA™ includes paying an even money payout (i.e., 1 to 1 payout) on a winning wager designated for the banker hand (as opposed to the traditional 19 to 20 fixed payout for winning banker-hand-designated wagers (i.e., a 95% payout, with the other 5% being retained by the house as a commission)), except when the winning banker hand wins with a three-card score of seven, in which case it is a push.

Blackjack is another popular wagering game played in casinos and other gaming establishments Like baccarat, some alterations to traditional blackjack have been proposed, including side bets made while playing blackjack. For example, the ROYAL MATCH 21® game is a side bet on blackjack focusing on the first two cards a player is dealt. To begin each round, players make the standard blackjack wager and the ROYAL MATCH 21® side wager. Players are dealt their first two cards, and, if the cards are the same suit or a king and queen in suit, they win. If both the player and the dealer receive a king and queen in suit, an optional CROWN TREASURE™ bonus payout is awarded. The bonus payouts apply to the player's first two cards only. As another example, the BET THE SET 21® game also focuses on a player's first two cards dealt. To begin each round, players make their standard blackjack wagers and the BET THE SET 21® side wager. Once each player has received his first two cards, the dealer settles all side wagers. If a player has any pair, they win according to a posted pay table. As yet another example, KING'S BOUNTY™ blackjack is a blackjack side bet that pays when a player's first two cards has a numerical point total twenty. All face cards have a point value of ten. To play, players make a standard blackjack wager and the side bet. The dealer deals blackjack according to house procedures. Players win the side bet if the point value of the first two player cards adds up to twenty. The top award occurs when a player has two kings of spades and the dealer has blackjack. This top award may be achieved only when the game is dealt from a multiple deck shoe.

### BRIEF SUMMARY

In some embodiments, methods of administering wagering games may comprise accepting from a player a primary wager on a primary wagering game to be performed in accordance with primary game rules. A secondary wager on a secondary wagering game, to be performed in accordance with secondary game rules, may be accepted from the player. Cards are dealt to a player hand and to a banker hand. The secondary wager is resolved based at least in part on dealt cards and in accordance with the secondary game rules. For winning outcomes on the secondary wager, a secondary payout is allocated in accordance with received instructions directing allocation of the secondary payout amongst an allocation group comprising the player, the primary wager, and another primary wager. Wagers on the primary wagering game are resolved based in part on the dealt cards and in accordance with the primary game rules. Resolving the wagers on the primary wagering game comprise resolving the primary wager including any allocation from the secondary payout allocated toward the primary wager and resolving any other allocation from the secondary payout allocated toward the another primary wager.

In some embodiments, methods of administering a wagering game may comprise accepting from a player a primary wager on a game of baccarat to be performed in accordance with baccarat rules. A secondary wager may be accepted from the player on a side game to be performed in accordance with side game rules differing from the baccarat rules. The secondary wager is designated to a secondary designated hand selected from a player hand and a banker hand. Two player cards are dealt to the player hand and two banker cards are dealt to the banker hand, such that the secondary designated hand comprises two designated cards. The secondary wager is resolved. Resolving the secondary wager comprises determining whether the two designated cards are of equal rank to one another. If determined that the two designated cards are of equal rank to one another, a secondary payout is awarded. If the secondary payout was awarded, the secondary payout is allocated in accordance with instructions received from the player directing allocation of the secondary payout to at least one of an allocation group comprising the player, the primary wager, and another primary wager. Wagers on the game of baccarat are resolved in accordance with the baccarat rules. Wagers on the game of baccarat comprise the primary wager, secondary payout allocations to the primary wager, and secondary payout allocations to another primary wager.

Further embodiments may include one, some, or all of the following: The acts of the dealer may be carried out by a visual representation of a dealer, the visual representation being generated and/or displayed by a computer. The visual representation may be a virtual person (e.g., an animation) or may be a transmission (e.g., a video) of an actual person. The visual representation may be part of an online gaming experience of the disclosed game. The acts described in this disclosure associated with a dealer, including dealing cards, displaying or turning cards over, receiving or paying bets, or any other actions, may be represented in any way when used in an online environment. For example, the cards associated with a dealer action, described as being dealt or otherwise handled by a dealer, may appear as virtual cards or as transmitted pictures of physical cards. This may include a display of virtual card decks where each deck, individual card, and hand is displayed to an online player in a manner consistent with the game play disclosed herein, but may or may not include a visual representation of a dealer with the cards. Likewise, betting activity may be displayed in any manner to a player, including, but not limited to, virtual chips, betting pools, numbers, or other indicia of a bet amount. In some embodiments, only dealer cards are displayed, and a virtual dealer is not displayed.

The online experience may involve players playing remotely (e.g., in a different physical location) from the dealer, the location of a game server, or both, interacting through a networked connection that may include, but is not limited to, the Internet. The online game play may involve players who are also physically remote from each other. Remote connections may use networks involving several types of network links including, but not limited to, the Internet. Networked connections allowing physically remote players to play a game using a game server or system may be part of an implementation of a virtual or online gaming environment.

The actions described in this disclosure as the acts of a player, including betting, card selection (if any), card discards (if any), or any other actions, may be carried out over a network where the indicated actions are received as input to a device. The input-receiving device is typically physically remote from the game server or game host and connected over a long-distance network, but could be implemented over a wired or wireless LAN in one building, or even in one room, for example. In one embodiment, game play generated at the server or host location may be displayed on the same device as the receiving device. In some embodiments, game play may be conveyed to remote players in devices separate from the devices receiving input from a player, such as public screens or publicly broadcast data about a game coupled with individual or private input devices. The reception of an input at a device may be accomplished through any technology adapted for such a purpose including, but not limited to, keypads, keyboards, touchpads, electronic tablets, cellphones, mice, optical location devices, eye movement/location detectors, sound input devices, etc. When discussing a device, it is understood the device may comprise multiple components and be complex, including hardware components combined with firmware and/or software, and may itself be a subcomponent of a larger system.

Yet other embodiments may comprise apparatuses and systems for administering wagering games according to embodiments of the disclosure.

### BRIEF DESCRIPTION OF THE DRAWINGS

While the disclosure concludes with claims particularly pointing out and distinctly claiming embodiments within the scope of the disclosure, various features and advantages of embodiments encompassed by the disclosure may be more readily ascertained from the following description when read in conjunction with the accompanying drawings, in which:

FIG. 1 is a flowchart diagram of a method of administering a wagering game;

FIG. 2A is a diagram of a playing surface for an implementation of a baccarat-based embodiment of a wagering game;

FIG. 2B is an enlarged diagram of a player area of a playing surface for an implementation of a baccarat-based embodiment of a wagering game;

FIG. 3 is an enlarged diagram of a player area of a playing surface for a live game table implementation of a three-card-baccarat-based embodiment of a wagering game;

FIG. 4 is a diagram of a playing surface for a live gaming table implementation of a blackjack-based embodiment of a wagering game;

FIG. 5 is an enlarged diagram of a player area of the playing surface of FIG. 4;

FIG. 6 is a diagram of a playing surface for a live gaming table implementation of a three-card-poker-based embodiment of a wagering game;

FIG. 7 is an enlarged diagram of a player area of the playing surface of FIG. 6;

FIG. 8 is a perspective view of an individual electronic gaming device configured for implementation of embodiments of wagering games;

FIG. 9 is a top view of a table configured for implementation of embodiments of wagering games;

FIG. 10 is a perspective view of another embodiment of a table configured for implementation of embodiments of wagering games, wherein the implementation includes a virtual dealer;

FIG. 11 is a schematic block diagram of a gaming system for implementing embodiments of wagering games;

FIG. 12 is a block diagram of a computer system for acting as a gaming system for implementing embodiments of wagering games; and

FIG. 13 is a schematic of a scratch card implementation of an embodiment of a wagering game.

### DETAILED DESCRIPTION

The illustrations presented herein are not meant to be actual views of any particular act in a method of administering a wagering game, apparatus for use in administering a wagering game, or component thereof, but are merely idealized representations employed to describe illustrative embodiments. Thus, the drawings are not necessarily to scale. Additionally, elements common between figures may retain the same or similar numerical designation. Elements with the same number, but including a different alphabet character as a suffix should be considered as multiple instantiations of substantially similar elements and may be referred to generically without an alphabet character suffix. For example, elements 10a, 10b, and 10c may be a device that is instantiated three times and generically referred to herein as element 10.

The terms “gaming,” “gambling,” or the like, refer to activities, games, sessions, rounds, hands, rolls, operations, and other events related to wagering games such as web-based games, casino games, card games, dice games, and other games whose outcome is at least partially based on one or more random events (“chance” or “chances”), and on which wagers may be placed by a player. In addition, the word “wager,” “bet,” “bid,” or the like, refer to any type of wager, bet, or gaming venture that is placed on random events, whether of monetary or non-monetary value. Points, credits, and other items of value may be purchased, earned, or otherwise issued prior to beginning the wagering game. In some embodiments, purchased points, credits, or other items of value may have an exchange rate that is not one-to-one to the currency used by the user. For example, a wager may include money, points, credits, symbols, or other items that may have some value related to a wagering game. Wagers may be placed in wagering games that are “play for pay” as well as “play for fun,” as will be described in more detail below.

Disclosed embodiments relate generally to methods of administering wagering games including accepting a primary wager on a primary wagering game and accepting a secondary wager on a secondary wagering game with a secondary payout from resolving the secondary wagering game allocated to at least one of a winning player and a wager on the primary wagering game. Thus, winnings from the secondary wagering game may be re-wagered in the primary wagering game of the same round of play. The allocated secondary payout may be allocated to the same primary wager accepted earlier in the round or may be allocated to a new and different wager in the primary wagering game, even on a hand already known to be meet a winning qualification.

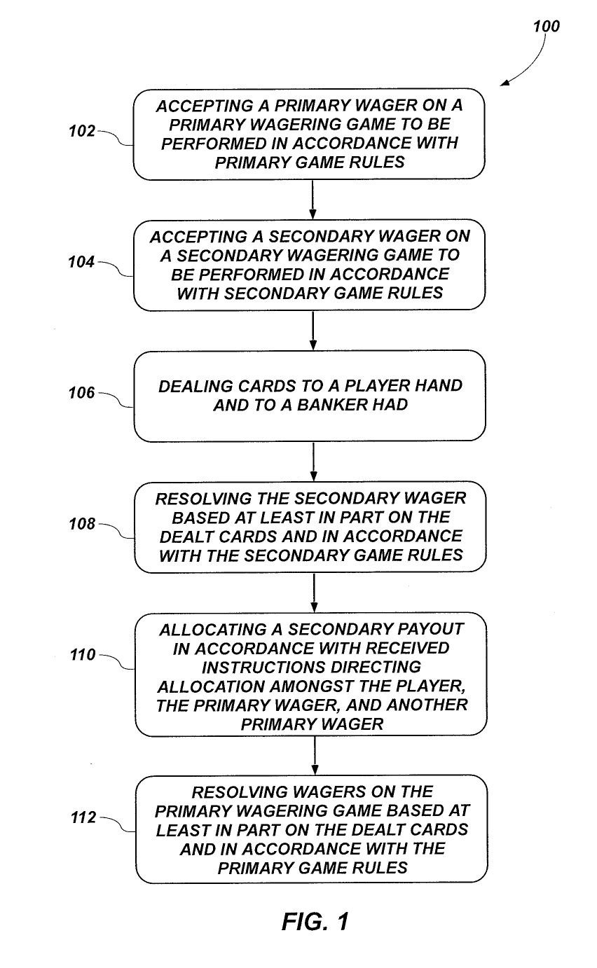

A flowchart diagram 100 of a method of administering a wagering game is shown in FIG. 1. The method includes accepting a primary wager on a primary wagering game to be performed in accordance with primary game rules (stage 102), accepting a secondary wager on a secondary wagering game to be performed in accordance with secondary game rules (stage 104), dealing cards to a player hand and to a banker hand (stage 106), resolving the secondary wager based at least in part on the dealt cards and in accordance with the secondary game rules (stage 108), allocating a secondary payout in accordance with instructions directing allocation amongst the player, the primary wager, and another primary wager (stage 110), and resolving wagers on the primary wagering game based at least in part on the dealt cards and in accordance with the primary game rules (stage 112).

With further reference to FIG. 1, administration of the wagering game may begin, as indicated at stage 102, with accepting a primary wager on a primary wagering game. The primary wager may be received from one or from each of a number of participating players. In some embodiments, the primary wager is mandatory (i.e., is a prerequisite for participation in play of both the primary wagering game and the secondary wagering game, although there may be additional prerequisites to initiate or qualify a player for play in the primary or secondary wagering game).

The primary wager may be received before or after cards are dealt and before or after other wagers are received in the same round. However, the primary wager may be received before cards are revealed to the player.

In some embodiments, the primary game rules include consideration of a player hand only and not consideration of a dealer hand (or banker hand). It may be desirable to keep all dealer cards face down until the secondary wager is resolved in such embodiments. In embodiments where the primary game rules comprise blackjack rules, the player hand and the banker hand (or dealer hand) may be permitted to accept additional hit cards, accept insurance wagers, accept elections to split pairs, etc., as with standard blackjack rules. As another example, the primary game rules may include baccarat rules, which may involve dealing two cards each to a player and a banker hand and, in some circumstances, dealing additional cards to complete the player hand and the banker hand. Administering the primary game may also include consideration of cards in a player hand and cards in a banker hand after all card dealing has concluded.

As indicated at stage 104, a secondary wager may be accepted from the player or from each of the number of participating players. The secondary wager may be performed in accordance with a different set of game rules from those in accordance with which the primary game is to be performed. In some embodiments, the secondary game rules may include consideration of a player hand (or player cards) only, and not consideration of a banker hand (or dealer hand) in determining a secondary game outcome. In such embodiments, it is contemplated that all banker (or dealer) cards may not be revealed until after the secondary wager is resolved. For example, the secondary game may comprise comparing a player hand's two-card poker hand ranking against a pay table of predetermined winning hand combinations and corresponding payout odds. In other embodiments, the secondary wagering game may include consideration of only cards initially dealt to a player hand and to a banker hand and not consideration of cards that may be subsequently dealt to the player hand, the banker hand, or both. The secondary game rules may include, for example, blackjack rules and may allow the player hand and the banker (or dealer) hand to receive two cards. In some embodiments, the secondary wager is optional. In other embodiments, the secondary wager is mandatory.

For example, the second set of rules may comprise comparing a player's two-card poker hand against a pay table of predetermined winning hand combinations and corresponding payout odds. In other embodiments, the second set of game rules may include consideration of only cards initially dealt to a player hand and to a banker hand and not consideration of cards that may be subsequently dealt to the player hand, the banker hand, or both. The secondary game rules may include, for example, blackjack rules and may allow the players and dealer (banker) to initially receive two cards.

In embodiments that require the dealer to accept a primary wager from the player to qualify the player to participate in the game, the primary and secondary wagers may be accepted before any cards are dealt to prevent players from viewing cards involved in the resolution of the primary wager before placing the secondary wager and from viewing cards involved in the resolution of the secondary wager before placing the primary wager. In embodiments where the secondary wager is optional, when the dealer receives an election from the player not to make the secondary wager, the primary wager may be placed first. In some forms of the game, the secondary game is resolved before the primary game, and the primary game requires consideration of more cards than the secondary game, allowing for suspense to build as the game proceeds, which may entice players to participate in the wagering game and specifically to place both the primary and secondary wagers.

The secondary wager may be received prior to, simultaneously with, or subsequent to receipt of the primary wager. In some embodiments, receipt of the secondary wager may precede dealing or, at least, revealing of any cards to the player.

Cards may be dealt to at least one player hand and to a banker hand (or a dealer hand), as indicated at stage 106. For example, cards may be dealt to a player hand and to a banker hand, and each player may be wagering on the outcome of those common hands, rather than on the outcome of individual hands, as is generally the case with baccarat. As another example, each player may receive cards available only to the individual players, respectively, and the dealer may similarly be dealt cards, as is generally the case with poker or blackjack.

The secondary wager is resolved according to the secondary game rules, as indicated at stage 108. In some embodiments, the secondary wager may be resolved based at least in part on cards dealt, for example, in stage 106. In some embodiments in which the dealer is dealt cards, the dealer cards may be dealt face down. In such embodiments, the secondary wager may be resolved first, according to the secondary game rules, without revealing or considering the dealer cards. Resolving the secondary wager before revealing the dealer cards may keep players engaged and builds excitement for the resolution of the primary wager. In other embodiments, dealer cards may be used to resolve the secondary wager, which may entice players to place the secondary wager because more information may be available to them with which to decide how to allocate winnings from the secondary wager.

An instruction may be accepted from each player, for whom the secondary wager is resolved in favor of the player, to award at least a portion of winnings (referred to herein as a “secondary payout”) from the secondary wager directly to the player or to add at least a portion of secondary payout from the secondary wager to the primary wager previously received or to another primary wager. Thus, the secondary payout is allocated in accordance with received instructions directing allocation amongst the player, the primary wager, and another primary wager, as indicated at stage 110.

An aspect of games of the present invention that is believed to be an attractive feature is that intermediate winnings on the secondary wager may be wagered in the primary game within the same round of play. The player may have the choice of receiving return of the secondary wager and receipt of the winnings on the secondary wager or applying all or part of the secondary wager and the winnings to the primary wager or another primary wager. In some embodiments, only all or part of the secondary payout amount can be allocated to a wager on the primary wagering game (i.e., to the previously-placed primary wager or to another primary wager). In other embodiments, all or part of the winnings from the secondary wager as well as all or part of the amount originally wagered as the secondary wager may be allocated to the primary wager or another primary wager option. In some embodiments, allocating the secondary payout to the primary wager may involve merely increasing the amount of the primary wager, with the required outcome (i.e., a winning condition of the primary wagering game) to win on the primary wager remaining the same. In other embodiments, allocating from the secondary payout to the primary wager may involve hedging on the outcome of the primary wager, with the amount originally placed on the primary wager being designated for a first outcome and the allocation from the secondary payout being designated for a second, different outcome. For example, a player who placed a primary wager designating a player hand to win, may allocate at least a portion of winnings from the secondary wager, and/or the secondary wager itself, to another primary wager designating a banker hand to win, which may be particularly enticing where the initial cards for the player and banker hands are dealt face up, giving the players significant quantities of information on which to base their allocation decisions. Regardless of the amount of the secondary payout allocated to the primary wager or to another primary wager, allowing the player to put payouts from a game at risk in the same game may create the impression that the player is being permitted to play with the casino's money. However, the player has, in actuality, already won these amounts at conclusion of resolving the secondary wager, and he or she is free to take these secondary payouts (i.e., to allocate the secondary payouts to him or herself) rather than allocate them toward another wager in the same round. For those players who like to win larger payouts, these payouts can be re-wagered in the same round, giving the player the potential of increasing payouts.

In embodiments where the individual players are dealt two-card hands, respectively, resolving the secondary wager may involve determining whether the player holds (or the player hand includes) a two-card poker hand of a predetermined rank or higher. Such resolution of the secondary wager, and the resulting allocation of the secondary wager and winnings therefrom, may be performed before the primary wager is resolved. For example, the secondary game rules may include comparing a player hand with a set of predetermined winning poker hands. The poker hand ranking systems are well-known and depend upon the number of cards the player may use to make a poker hand. For example, the hierarchy of two-card poker hands may be different from three-card, four-card, and five-card, etc., poker rankings. Players may receive cards to make a best two-, three-, four-, five-, six-, or seven-card poker hand, for example. The different set of game rules may be selected from the group consisting of two-card poker rankings, three-card poker rankings, four-card poker rankings, five-card poker rankings, six-card poker rakings, and seven-card poker rankings. Other alternative embodiments may include allowing players to discard and receive one or more cards to better their hand, may include one or more extra wild cards, or may include designating one or more cards in the set as wild.

In embodiments where a two-card hand is dealt to each of a player hand and a banker hand, with all cards face up, resolving the secondary wager may involve determining whether the cards in the one of the player hand and the banker hand for which the secondary wager has been designated consists of two cards of equal rank to one another. In other embodiments, resolving the secondary wager may involve determining whether any pair of cards of equal rank have been dealt to one or both of the player hand and the banker hand. That is, resolving the secondary wager may involve determining whether cards in the player hand are of equal rank to one another, the cards in the banker hand are of equal rank to one another, or the cards in the player hand are of equal rank to one another and the cards in the banker hand are of equal rank to one another.

Determining whether cards are of equal rank to one another may require that the cards be precisely equal in rank (e.g., both fours or both kings) (i.e., of equal poker rank), such that a secondary wager designated for the player hand may be resolved as a win where the player hand is dealt two five cards (but not where the player hand is dealt a jack and a queen). Alternatively, determining whether cards are of equal rank to one another may be based on modulo 10 rules (e.g., both nines, both aces, or one queen and one ten).

In some embodiments in which the secondary wager is received with a designation for only one of the player hand and the banker hand, winning outcomes on the secondary wager may be awarded an odds payout, such as a secondary winnings of six times the amount of the secondary wager.

In other embodiments in which the secondary wager may be received without a specific designation, players may be awarded a larger payout when the cards in the player hand are of equal rank and the cards in the banker hand are of equal rank than a payout for when only the cards in the player hand are of equal rank or only the cards in the banker hand are of equal rank. For example, players may be awarded an odds payout of 15 to 1 on the secondary wager when cards in the player hand are of equal rank and the cards in the banker hand are of equal rank, while an odds payout of 3 to 1 may be paid on the secondary wager when only the cards in the player hand are of equal rank or only the cards in the banker hand are of equal rank.

In some embodiments, the players placing the secondary wager may designate only the same hand for which the primary wager was designated. In embodiments not requiring separate hand designation for the secondary wager, the player may win on the secondary wager only when the hand having cards of equal rank is also the hand for which the primary wager was designated. In other embodiments not requiring separate hand designation for the secondary wager, the player may win on the secondary wager if either the player hand or the banker hand has cards of equal rank, regardless of which of the tie outcome, the player hand win, and the banker hand win was designated for the primary wager.

After resolving the secondary wager and allocating any secondary payouts, the primary wager may be resolved, as indicated at stage 112, according to the primary game rules. In some examples of the wagering game, the primary game rules comprise baccarat rules and a baccarat hand scoring system is applied to compare the total point value of individual player and banker hands or of a common player hand and banker hand, according to a modulo 10 scoring system. In other embodiments, the primary game rules comprise blackjack rules. In yet other embodiments, the primary game rules comprise three-card poker rules and the primary wagering game involves a three-card player poker hand competing against a three-card dealer's poker hand.

In some embodiments, players receive separate sets of player cards. The dealer may also receive dealer cards. Common cards may also be dealt. In the examples described below, players receive the exact number of cards used to make a player hand. In other embodiments, players are dealt one or more extra cards and then can make a best hand from the available cards. For example, in embodiments that require the dealer to dispense an extra card to each player for a two-, three-, four-, five-, six-, or seven-card poker game, the dealer would deal to each player three, four, five, six, seven, or eight cards, respectively. In some forms of the game, all of the player cards are dealt to a player position and are used exclusively by the player who made the wager or wagers. In other embodiments, one or more of the player cards are dealt to a common card position. Cards dealt to the common card position may be used by all players, the dealer, or just some of the players, depending upon the game rules.

Baccarat/Side Game Based on Initial Cards Dealt with Allocation of Winnings from Side Game to One of Player and a Banker Wager on Baccarat Game

In at least one embodiment of a method of administering a wagering game, a primary wagering, e.g., based on baccarat rules, and a secondary wagering game, e.g., based on different rules, may be administered in the same round of play. A primary wager may be received from a player to qualify the player to participate in play of the primary wagering game, e.g., baccarat. The primary wager received may be designated, by the player, for a particular outcome of the primary wagering game, i.e., for a “primary outcome.” The primary outcome may be selected, e.g., by the player, from a tie outcome and a “hand win” outcome. A tie outcome may result when a player hand and a banker hand have module 10 point values equal to one another. A hand win outcome may result when one of the player hand and the banker hand has a higher module 10 point value than the other, but players may designate only one of the player hand and the banker hand as the “primary designated hand” on which the hand win outcome is to be resolved. Thus, a primary wager designating the player hand as the primary designated hand may constitute a wager that the player hand will have achieve a higher modulo 10 point value than the banker hand. A primary wager designating the banker hand as the primary designated hand may constitute a wager that the banker hand will achieve a higher module 10 point value than the player hand. A primary wager designation for the tie outcome may constitute a wager that the module 10 point value of the player hand will equal the module 10 point value of the banker hand.

The primary wager may be, for example, a mandatory wager, such that receipt of the primary wager may be a prerequisite to qualify the player to participate in the primary wagering game and any other wagering games (e.g., the secondary wagering game) of the round.

A secondary wager may be received from a player to qualify the player to participate in play of a secondary wagering game. The secondary wager may be optional, in which case receipt of the secondary wager may not be a prerequisite to qualify the player to participate in play of the primary wagering game. In other embodiments, the secondary wager may be mandatory, such that receipt of both the primary wager and the secondary wager may be required to qualify the player to participate in the primary wagering game while also qualifying the player to participate in the secondary wagering game. In embodiments in which the wagering game is administered to more than one participating player, the secondary wager may be received from one or more of the participating players, wherein receipt of the secondary wager from any participating player qualifies that player to wager on the outcome of the secondary wagering game.

An amount of the secondary wager may be limited in accordance with a predetermined maximum amount. The predetermined maximum limit may be displayed on or near a table or device on or with which the wagering game is to be implemented.

Receiving the secondary wager may include requiring that the secondary wager be designated toward a specific hand of the player hand and the banker hand in the round of the wagering game being played. In such embodiments, the player may place his or her secondary wager while designating the secondary wager for a “secondary designated hand” selected from the player hand and the banker hand. Resolving the secondary wager, thereafter, may be based at least in part on the secondary designated hand.

In other embodiments, more than one secondary wager may be received from a player, with each received secondary wager still designated for a particular one of the player hand and the banker hand. For example, one secondary wager may be designated for the player hand and another secondary wager may be designated for the banker hand.

In still other embodiments, a single secondary wager may be designated in portions toward more than one hand. For example, a single secondary wager may be received with a designation that one-half (50%) of the secondary wager is wagered on the player hand and the other one-half (50%) of the secondary wager is wagered on the banker hand. For example, a ten dollar secondary wager may be received with an indication that one portion (e.g., five dollars) is designated for the player hand and another portion (e.g., five dollars) is designated for the banker hand.

In still other embodiments, a secondary wager may be received with a designation for any one of the player hand, the banker hand, or both the player hand and the banker hand. For example, a secondary wager designated for both hands may be a wager that both the player hand will receive a pair as its first two dealt cards and the banker hand will receive a pair as its first two dealt cards.

In some embodiments, the secondary wager may be received with a secondary hand designation that is the same as or different from the primary designated hand. For example, from one player, a primary wager may be received designated for a hand win outcome on the banker hand while a secondary wager may be received designated for the player hand as the secondary designated hand. Therefore, resolving the secondary wager may be based on a hand of cards that is the same or different from a hand of cards on which resolving the primary wager is based. In any regard, the cards of the hand or hands on which the secondary wager and the primary wager are resolved may be cards dealt in the same round and, in some embodiments, during the same dealing stage.

Cards may be dealt to at least one of the banker hand and the player hand. Dealing cards may follow receipt of amounts wagered in the round. For example, dealing cards may follow receipt of the primary wager, from any player wishing to participate in the round, and the secondary wager, whether required or optional, from any player wishing to also participate in the secondary wagering game.

Cards may be dealt in one or more dealing stages and may be dealt face down or face up. In some embodiments, the number of cards on which resolving the secondary wager is to based may be dealt, in an initial dealing stage, to each of the player hand and the banker hand. Card dealing may be complete at this point, depending on the outcome of the initial dealing stage (e.g., naturals dealt to both the player hand and the banker hand) or may be later completed.

Following dealing of at least the number of cards on which resolving the secondary wager is to be based, the secondary wager may be resolved. Resolving the secondary wager may be based on a predetermined grouping of cards in the hand designated at receipt of the secondary wager. For example, the secondary wager may be resolved based on a first number of cards (e.g., first two cards) dealt to the designated hand. In some embodiments, resolving the secondary wager may also be based on whether the predetermined grouping of cards meets or at least meets a predetermined ranking. For example, a winning outcome on the secondary wager may require the first two cards dealt to a designated hand to have the rank of a pair. A pair may be defined equal poker ranking (e.g., a jack and a jack, not a jack and a queen). In other embodiments, a pair may be defined by equal modulo 10 point value (e.g., a jack and a jack; a jack and a queen; etc.).

Resolving the secondary wager may be based on cards from only the hand for which the secondary wager was designated (i.e., on card from only the secondary designated hand), and may be independent of the other hand. For example, for a secondary wager designated for the banker hand, a winning outcome may result if the first two cards dealt to the banker hand are both threes, regardless of whether the first two cards dealt to the player hand are of equal or different ranks. Accordingly, the secondary wager may be resolved based on only the first two cards of the particular hand (of the player hand and the banker hand) for which the secondary wager has been received. For winning outcomes on the secondary wager, a secondary payout of six to one (6:1) may be distributed to each player from whom the secondary wager was received and for which resolving the secondary wager resulted in a winning outcome. Other payout odds are contemplated, such as payout odds between 1:3 and 1:10, for example.

In other embodiments, the secondary wager may be resolved based on cards of either hand or of both hands, such that receipt of the secondary wager may not be in association with a designation of a particular hand of the player hand and the banker hand. In such other embodiments, a secondary payout may be of one amount (e.g., three to one) if a pair is dealt to one of the player hand and the banker hand and may be of a greater amount (e.g., fifteen to one) if a pair is dealt to the player and a pair is dealt to the banker hand.

After resolving the secondary wager, the winnings from the secondary wager are allocated between at least one of the winning player and a wager on the primary wagering game where the allocation made is carried out in accordance with an instructions received from the winner of the secondary wager. Instructions permitted may include allocating the secondary payout to the player, to the previously-made primary wager (i.e., adding to the primary wager placed earlier in the betting round and awaiting resolution, wagering on the same outcome for which the earlier-placed primary wager was designated), or to another primary wager (i.e., designating a different outcome than that for which the earlier-placed primary wager was designated). Payouts on the secondary wager may also be split between a player allocation, and one or more primary wager options.

In some embodiments the another primary wager, to which the secondary payouts may be allocated, may be selected from an allocation group comprising the tie outcome and a hand win outcome with designation of one of the player hand and the banker hand. Accordingly, in such embodiments, both the primary wager and the secondary payout allocation may be placed on any of a selection of the tie outcome, a player hand win outcome, and a banker hand win outcome.

In other embodiments, the allocation group may be limited to only primary wagers designating the player hand or the banker hand, but not the tie outcome. In such embodiments, if the primary wager had been designated for the tie outcome, the secondary payouts may be allocated between only the player and another primary wager designating another primary designated hand selected form the player hand and the banker hand.

In some embodiments, instructions permitted for directing allocation of the secondary payout include instructions to allocate the secondary payout in portions (e.g., in two or more portions), rather than in total. For example, a secondary payout may be allocated one-third to the original primary wager (i.e., to the same hand of the player hand and the banker hand for which the primary wager had previously been designated), another one-third to a tie outcome on the primary wager, and the remaining one-third transferred to the player. It is contemplated that the allocation instruction may be received in terms of fractions or monetary amounts or any other means by which to define the portions to be allocated. The allocation instruction may be received audibly, electronically, or in any other communication form from the player. The player may be prohibited from making the allocation him- or herself. In other embodiments, the player may be allowed to carry out the allocation him- or herself, in which case allowing the allocation before carrying on with the method of administering the wagering game accomplishes the allocation in accordance with the instruction from the player. It is to be understood that amounts wagered, amounts won or amounts wagered and won can be allocated or partially allocated.

As used herein, the term “secondary payout” includes both the amount of the secondary wager and amounts won from the secondary wager. Therefore, if a $1 secondary wager is successful, such that an amount of $6 may be won on the secondary wager, $7 constitutes the “secondary payout” to be allocated.

Allocating all or some of the secondary payout “to the player” may include leaving the instructed amount of the secondary payout on a table as a secondary wager for a subsequent round of the wagering game. Therefore, allocating the secondary payout to the player is accomplished by recognizing the player's established right to take possession or ownership of the secondary payout, regardless of whether or not the player elects to actually take possession or ownership of the secondary payout.

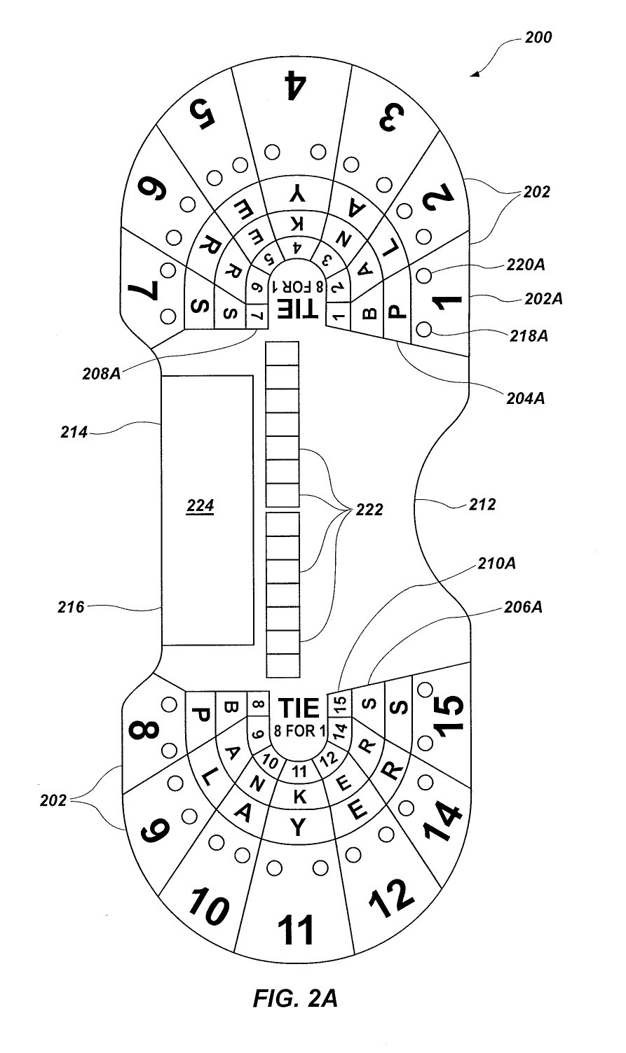

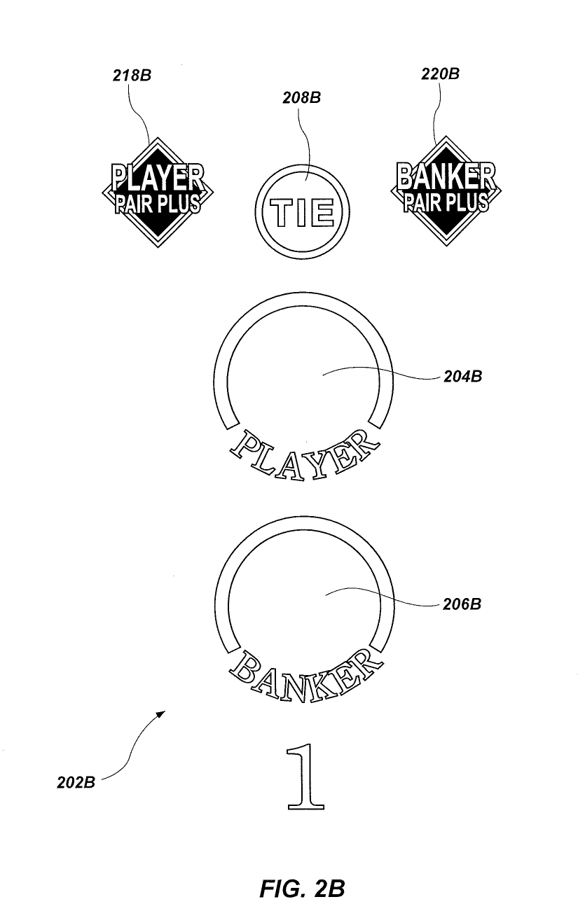

With reference to FIG. 2A, embodiments of such methods for administrating wagering games may be incorporate use of a baccarat-type wagering game table 200. The game table 200 may have fifteen player positions 202, which may be numbered with numeral indicia (e.g., “1” through “15”). For example, a first player position 202A may be numbered with “1.” A distinct player hand wager area 204A may be labeled P-L-A-Y-E-R-S, with each letter proximate to a different player position 202, for receipt of primary wagers designated for the player hand as the primary designated hand. Adjacent to the player wager area 204A may be a banker hand wager area 206A labeled as B-A-N-K-E-R-S for placement of wagers designated for the banker hand and the primary designated hand. Further interior on the table 200 may be a series of spaces 208A bearing numerical indicia (e.g., “1,” “2,” “3,” “4,” “5,” “6,” and “7”) and spaces 210A bearing numerical indicia (e.g., “8,” “9,” “10,” “11,” “12,” “14,” and “15”) (one space for each potential participating player (i.e., wagerer)) for placement of a primary wager designating the tie outcome.

The table 200 may include positions for more than one dealer, i.e., for a caller (a casino operator who calls the cards), and for two dealers. The caller may be tasked with calling the action during the performance of the method, while the dealers may each be tasked with controlling physical articles involved in performance of the method, e.g., wagers and cards, one one-half of the table 200. A caller position 212 may be positioned between the “1” and the “15” player positions 202. A first dealer position 214, for the dealer overseeing play at the “1” through “7” player positions 202, may be positioned opposite the caller position 212 and proximate the “7” player position 202. A second dealer position 216, for the dealer overseeing play at the “8” through “15” player positions 202, may be positioned opposite the caller position 214 and proximate the “8” player position 202.

Each player position 202 may further include at least two secondary wagering areas, including a secondary wagering area 218A for designating the secondary wager for the player hand and a secondary wagering area 220A for designating the secondary wager for the banker hand. The secondary wagering area 218A may be designated for receiving secondary wagers placed by players wishing to bet that the first two cards dealt to the player hand will be a pair (i.e., two cards each having the same rank as the other). The other secondary wagering area 220A may be designated for receiving secondary wagers placed by players wishing to bet that the first two cards dealt to the banker hand will be a pair (i.e., two cards each having the same rank as the other).

With reference to FIG. 2B, illustrated is an enlarged, alternative player position (e.g., a first player position 202B) in which a player hand wagering area 204B, a banker hand wagering area 206B, and a space 208B for a tie wager are defined by betting circles printed on the layout. A secondary wagering area 218B for designating the secondary wager for the player hand and a secondary wagering area 220B for designating the secondary wager for the banker hand are also included.

In some embodiments, the secondary wagering areas 218A, 218B, 220A, 220B may be the only secondary wagering areas, such that wagers on the secondary wagering game are specific to a particular hand. In such embodiments, players may be prohibited from placing a secondary wager without designating the secondary wager for one of the player hand and the banker hand.

In other embodiments, a secondary wager may be accepted without specific designation of one of the banker hand and banker hand such that a winning outcome on the secondary wager may include a pair being dealt as the first two cards of either or both of the player hand and the banker hand. In such embodiments, different secondary wagering areas (not shown) may be included at each player position 202.

In other embodiments, more than one initial, secondary wager may be received, each secondary wager still designated for a particular one of the player hand and the banker hand. For example, one secondary wager may be designated for the player hand and another secondary wager may be designated for the banker hand. In other embodiments, a single secondary wager may be designated in portions toward more than one hand. For example, a single secondary wager may be received between secondary wagering area 218A or 218B and secondary wagering area 220A or 220B, such that the secondary wager may be received for half its value designated on the player hand and half its value designated on the banker hand. For example, a ten dollar secondary wager may be placed between the secondary wager area 218B associated with the player hand and the secondary wager area 220B associated with the banker hand.

With further reference to FIG. 2A, the table 200 may further include a placement position 222 for placement of wager payouts. The placement position 222 may be located in front of the dealer's positions 214, 216 with a chip tray 224 between.

In other embodiments, the table may be configured for use by fewer than three dealers, such as by two dealers. In still other embodiments, the table may be configured for use by one dealer, in which embodiments the table may be approximately half the size with approximately half the number of player positions.

In some embodiments, the table may distinguish areas for receipt of initial primary wagers from areas for receipt of allocated secondary winnings toward the primary wagering game. In other embodiments, the table may be configured to receive all initial and allocated wagers in the same designation areas without regard to whether the wagers were initially made or made by allocation subsequent to resolving the secondary wagers.

As a particular, non-limiting example of an embodiment of a method of administering a wagering game in accordance with the present disclosure, the method may include accepting a mandatory primary wager on a baccarat game to be performed in accordance with baccarat rules. The primary wager may be accepted with designation for any of a tie option, a player hand win option, and a banker hand win option. The tie option may pay 8:1 odds. The player hand win option and the banker hand win option may pay 1:1 odds with a commission taken on the banker hand by the house. An optional secondary wager on a side wager game may be accepted. The side wager game may be a wagering game involving, as a winning condition, two cards of equal rank (i.e., a jack and a jack, not a jack and a queen) being dealt as the initial two cards dealt to a secondary designated hand (i.e., the hand for which the secondary wager is designated). The secondary wager may be designated for either of the player hand and the banker hand. Two cards are then dealt to each of the banker hand and the player hand. The cards may be dealt face up or otherwise revealed after the primary wager and the secondary wager have been received but before the secondary wager is resolved. The secondary wager is resolved by determining whether the two cards dealt to the designated hand of the banker hand and the player hand consist of a pair of cards of equal rank. If so, secondary winnings in the amount of 6:1 odds based on the secondary wager are awarded (but not necessarily physically transferred to the player). The player then directs the allocation of the secondary payout (i.e., the secondary wager amount and the secondary winnings amount) to any one of the player him- or herself, the same primary wager already placed, or another primary wager. Thus, the player is not limited to taking possession of the secondary payout or to allocating the secondary payout to the same primary wager already placed (i.e., to the one of the tie outcome, the player hand win outcome, and the banker hand win outcome previously designated for the primary wager), but may allocate the secondary payout, or a portion thereof, to a different one of the tie outcome, the player win outcome, and the banker win outcome, even if such outcome has already been revealed to meet a winning condition of the primary game, or combinations thereof. For example, if a player placed a $5 primary wager on a player hand and placed a $1 secondary wager on either of the player hand and the banker hand, and if both the player hand and the banker hand were dealt a pair of 4's such that both hands are “naturals,” the initial deal of the cards would reveal that the hands would meet a tie outcome, which is a winning condition of the primary wagering game for wagers on the tie outcome. An instruction for directing the allocation is received from the player and, provided it is in accordance with house rules concerning the allocation, the secondary payout is allocated in accordance with the instruction received. So, in further regard to the aforementioned example, the player, having won $6 winnings on the secondary wager may give an instruction to have the $7 payout (including the $1 original secondary wager and the $6 secondary winnings) allocated in total to another primary wager designated for the tie outcome, which, at that point, is known to be a guaranteed win. Upon allocation of the secondary payout, the secondary wagering game is concluded. The primary wagering game is then resolved. In accordance with baccarat rules, up to two additional cards may be dealt. In further regard to the aforementioned example, no additional cards are dealt because both hands, as initially dealt, are “naturals.” The player may, therefore, win $56 (because of 8:1 odds on the tie outcome and the $7 secondary payout placed as the another primary wager). The primary winnings of $56 and the other primary wager of $7 may be distributed to the player, concluding the round of wagering. Another betting round may then commence.

Accordingly, a method of administering a wagering game may comprise accepting from a player a primary wager on a game of baccarat to be performed in accordance with baccarat rules; accepting from the player a secondary wager on a side game to be performed in accordance with side game rules differing from the baccarat rules, the secondary wager designated to a secondary designated hand selected from a player hand and a banker hand; dealing two player cards to the player hand and two banker cards to the banker hand, such that the secondary designated hand comprises two designated cards; resolving the secondary wager, comprising: determining whether the two designated cards are of equal rank to one another; and, if determined that the two designated cards are of equal rank to one another, awarding a secondary payout; if the secondary payout was awarded, allocating the secondary payout in accordance with instructions received from the player directing allocation of the secondary payout to at least one of an allocation group comprising the player, the primary wager, and another primary wager; and resolving wagers on the game of baccarat in accordance with the baccarat rules, wagers on the game of baccarat comprising the primary wager, secondary payout allocations to the primary wager, and secondary payout allocations to the another primary wager.

### Baccarat/Side Game Based on Initial Cards Dealt to Banker and Player Hands

In some embodiments, methods of administering wagering games may include administering an underlying game of baccarat while offering an optional side game based on the initial cards dealt to banker and player hands, according to baccarat rules. For example, a primary wager to participate in a game of baccarat may be accepted. The primary wager may comprise a wager that the banker hand will have a higher modulo 10 point value, the player hand will have a higher modulo 10 point value, or modulo 10 point values of the banker and player hands will tie. The primary wager may be, for example, a mandatory wager, such that, a player may not be permitted to participate in the game of baccarat or in the side game without placing the primary wager. A secondary wager to participate in a side game using cards initially dealt to each of the banker and player hands may be accepted. For example, the secondary wager may be optional, and fewer than all participating players may place the secondary wager. Two cards may be dealt to each of the banker and player hands. In other embodiments, the secondary wager is mandatory.

The secondary wager may be resolved according to whether the cards in the banker hand are of equal rank, the cards in the player hand are of equal rank, or the cards in the banker hand are of equal rank and the cards in the player hand are of equal rank. For example, a player may win the secondary wager when the cards in the player hand are both threes, the cards in the banker hand are a queen and a ten, or the cards in the player hand are a king and a jack and the cards in the banker hand are both aces. In one form of the game, the secondary wager is against both player and banker hands.

A payout may be awarded to each player for whom the secondary wager is resolved as a win. In some embodiments, a greater payout may be awarded, when the cards in the banker hand are of equal rank and the cards in the player hand are of equal rank, than a payout awarded when only the cards in the banker hand are of equal rank or only the cards in the player hand are of equal rank. For example, a fixed odds payout of 15 to 1 or another odds payout may be awarded when the cards in the banker hand are of equal rank and the cards in the player hand are of equal rank, and a fixed odds payout of 3 to 1 or another odds payout may be awarded when only the cards in the banker hand are of equal rank or only the cards in the player hand are of equal rank. The payout may be paid for cards of equal rank in the banker hand, the player hand, or both regardless of what outcome was predicted when placing the secondary wager. For example, a player may place the primary wager that the banker hand will win, but still win the secondary wager when the cards in the player hand are of equal rank.

An instruction may be accepted from each player for whom the secondary wager is resolved in favor of the player to award amounts wagered, winnings or amounts wagered plus winnings from the secondary wager directly to the player or to add or re-bet at least a portion of the winnings and/or amounts wagered from the secondary wager to the primary wager. For purposes of this disclosure, “winnings” may include amounts wagered and returned to the player after a winning event. In some embodiments, a player may allocate the winnings from the secondary wager between receiving them directly and adding them to the primary wager. In other embodiments, a player may only elect to receive all the winnings directly or add all the winnings to the primary wager. In some embodiments, a player may also elect whether to receive the amount of the secondary wager directly or to add it to the primary wager. In other embodiments, the amount of the secondary wager may be awarded directly to the player, with no opportunity to allocate (i.e., re-wager) it. In some embodiments, players may be required to add whatever amounts they have elected to re-wager to the same outcome on which they originally placed the primary wager. For example, a player who placed the primary wager on a banker win may only be permitted to add the elected secondary wager and/or payout amounts to a primary wager designated for the banker win outcome. In other embodiments, players may be permitted to hedge by adding whatever amounts they have elected to risk to an outcome different from an outcome on which they originally placed the primary wager. For example, a player who placed the primary wager on a predicted banker hand win may elect to place a portion of his winnings from the secondary wager on a predicted player hand win. This may entice players to make the secondary wager as a hedge against loss, particularly because more information is available to the players when allocating winnings from the secondary wager than when the secondary wager was initially placed. In fact, players may be enabled to roll winnings from the secondary wager and the amount of the secondary wager into a guaranteed winning hand in some instances because baccarat rules sometimes dictate that hands will win or lose based only on the first two cards dealt. In some embodiments where players are permitted to add whatever amounts they have elected to risk to an outcome different from an outcome on which they originally placed the primary wager, the players may be permitted to place the additional amounts only on a banker hand win or a player hand win, not on a tie.

After the secondary wager has been resolved and winning players have allocated their winnings, the primary wager may be resolved according to baccarat rules. Players who won the secondary wager and elected to add at least a portion of the winnings therefrom to the primary wager may, therefore, be enabled to roll their winnings into even greater winnings (i.e., may be playing with “house money”).

### Three-Card Poker Pay Table/Three-Card Baccarat

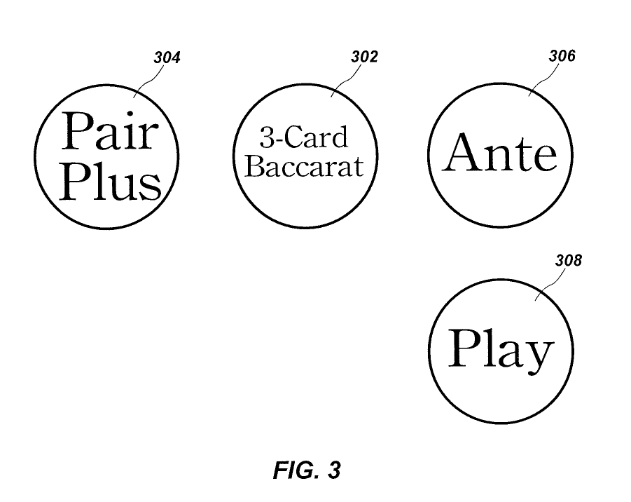

In another example of a method of administering a wagering game in accordance with the present disclosure, players and the dealer make a mandatory three-card baccarat primary wager 302 as shown in FIG. 3, a mandatory “pair plus” secondary wager 304, and an optional ante wager 306. The ante wager 306, in another embodiment of the wagering game, is mandatory. In alternate forms of the wagering game, no ante wager 306 is offered.

Players receive a three-card hand and review their cards. The player elects to play or fold if he made the optional ante wager 306. This act may be performed at any time up until the dealer's three cards are revealed. The secondary wager 304 is played first, before the dealer cards are exposed to the player and in order to maintain suspense in the game. After the dealer receives a player election to make a play wager 308 or fold, the former keeping the ante 306 in play and the latter resulting in a loss of the ante wager 306, the dealer reviews the player's revealed hand. If the player holds a predetermined winning three-card poker hand as shown in Pay Table I, below, the dealer may receive an election to pay the player a payout on the secondary wager 304, and return the secondary wager 304 to the player, or may receive an election to put all or part of the funds eligible for return on the baccarat bet (i.e., the primary wager 302). If the player holds a lower ranking poker hand than the minimum winning poker hand, the dealer takes the secondary wager 804.

The secondary game rules may comprise a three-card poker pay table such as Pay Table I below:

TABLE I

| Hand | Odds |
|---|---|
| Straight flush | 40 to 1 |
| 3 of a kind | 30 to 1 |
| Straight | 6 to 1 |
| Flush | 4 to 1 |
| Pair | 1 to 1 |

In some embodiments, prior to playing the secondary wager 304, or after the secondary wager 304 is played but before the primary wager 302 is played, players who made the ante wager 306 view the player cards and elect to make the play wager 308 or to check. The dealer then receives the election, including either the check or the play wager 308. The ante wager 306 stays in play. In other embodiments, the player must make the play wager 308 or fold. In some embodiments, the ante wager 306 is not offered or accepted.

After the play wager 308 or the check election is received, the primary wager 302 is resolved. The dealer reveals the dealer cards, and, at this point, all player and dealer cards are exposed. The primary wager 302 is made on the occurrence of a player three-card hand having a higher ranking hand than a dealer three-card hand, using baccarat scoring, modulo 10, as the rules of the first game. Unlike standard baccarat, no hit cards can be taken.

The player wins 1:1 on the baccarat bet (i.e., on the primary wager 302) if the player hand beats the banker hand. Ties go to the house. The dealer takes all wagers if the banker hand outranks the player hand. Last, all ante wagers 306 and play wagers 308 or just ante wagers 306 are resolved by comparing the player hand rank to the banker hand rank.

### Blackjack/Two-Card Poker Against a Pay Table

In another example of a method for administering a wagering game in accordance with the present disclosure, the wagering game may include a blackjack-based primary wagering game. Thus, the dealer administers a primary wagering game of blackjack and a secondary wagering game of two-card poker. According to the secondary game rules, the two-card poker game is played against a pay table and is played first, before the dealer hand is revealed to the player. The method includes the steps of accepting a primary wager to participate in a game of blackjack. The method also includes accepting a secondary wager to participate in a variant of a two-card poker game. Two cards are dealt to each player and to a dealer. The secondary wager is resolved according to whether the two cards of each player constitute a two-card poker hand of a predetermined rank or higher. The method includes accepting from each player in whose favor the secondary wager is resolved an instruction to award at least a portion of winnings from the secondary wager directly to the player or to add at least a portion of winnings from the secondary wager to the primary wager or to receive a payout. The primary wager is then resolved according to blackjack rules.

In other embodiments, the player is permitted to place all or part of the winnings from the secondary wager onto a dealer hand, which was not a betting option in the primary wagering game.

The two-card poker game is resolved by the dealer examining the player cards to determine whether the player holds a two-card straight, a pair, a straight flush, or an ace and a king of the same suit. Two examples of suitable pay tables are provided below. The first pay table (Table II, below) may be used when multiple decks of cards are used in the play of the game. The second pay table (Table III, below) may be used when a single deck of cards is used in the play of the game.

In other embodiments, the player is permitted to place all or part of the winnings from the secondary wager onto a dealer hand, which was not a betting option in the primary wagering game.

TABLE II

| Hand | Odds |
|---|---|
| Ace-king suited | 9 to 1 |
| Straight flush | 4 to 1 |
| Pair | 3 to 1 |
| Straight | 1 to 1 |

TABLE III

| Hand | Odds |
|---|---|
| Ace-king suited | 9 to 1 |
| Straight flush | 5 to 1 |
| Pair | 3 to 1 |
| Straight | 1 to 1 |

In some embodiments, the secondary wager is optional. If the dealer does not receive a player election to play the secondary wager, the player simply plays the primary wager. In other embodiments, the secondary wager is mandatory. The secondary wager is resolved prior to resolving the primary wager, otherwise the dealer cannot receive an election to move a secondary payout to the primary wager area before the primary wager is resolved.

When the player wins the secondary wager, the dealer may receive a play election to move all of the amounts won on the secondary wager, plus the amount of the secondary wager to the primary wager betting spot.

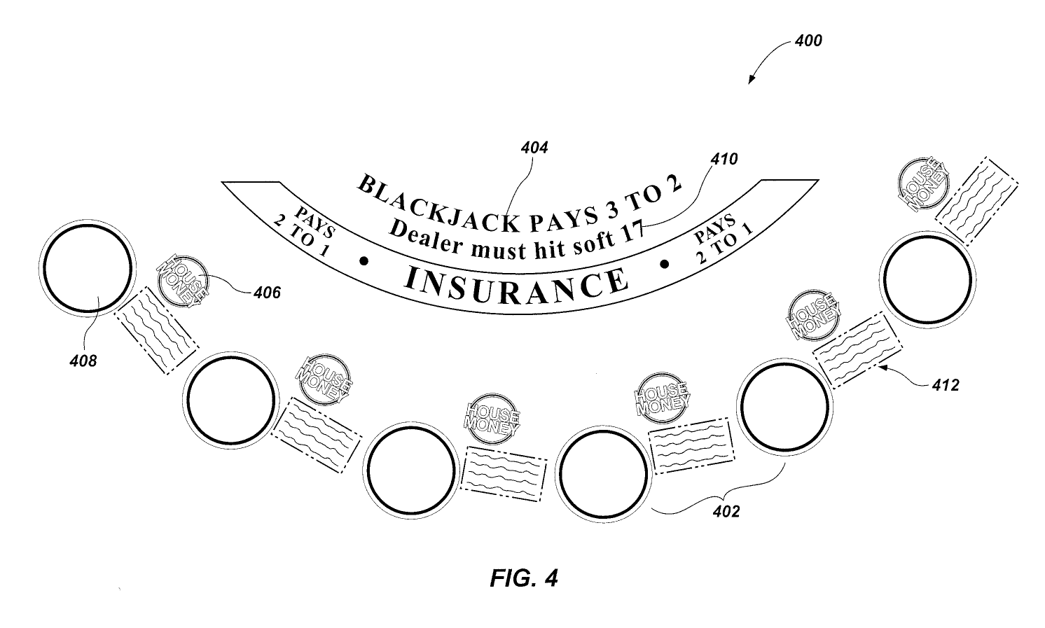

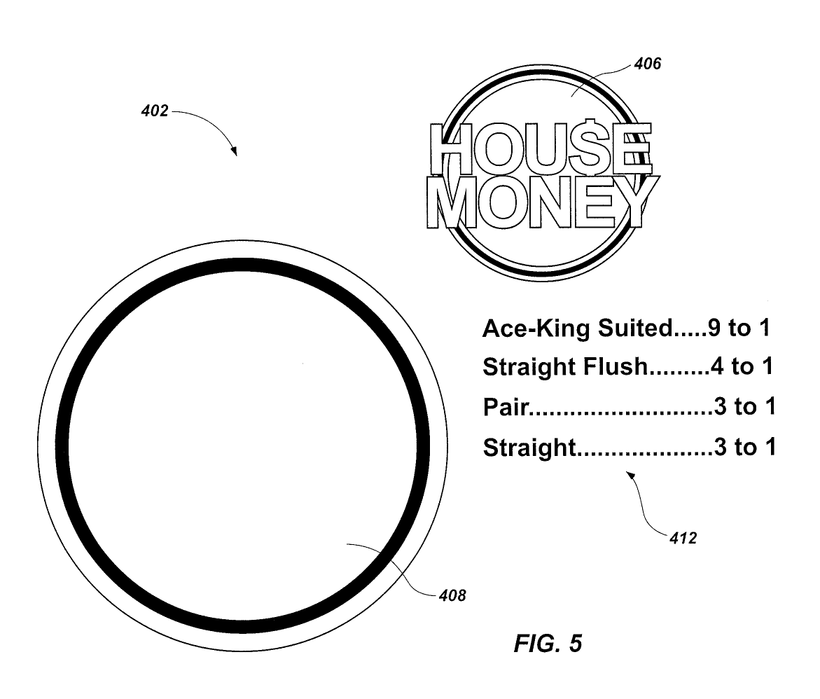

As illustrated in FIG. 4, this example of the game may be played on a cloth layout 400 with printed information and graphical designs. The layout 400 may include player areas 402, a dealer area 404, printed rules 410 for the primary game, and printed rules 412 for the secondary game. The dealer may receive the primary wager on a betting spot (e.g., a primary wager area 408), which designates participation in a blackjack game. Players may optionally make the secondary wager on another betting spot (e.g., a secondary wager area 406). The secondary wager is a two-card poker bet against a pay table, in which the player hopes to receive a two-card hand of a straight, a pair, a straight flush, or a royal flush. The printed rules 412 preferably include a pay table, which is shown in greater detail in FIG. 5. Each player area 402 includes the primary wager area 408, the secondary wager area 406, and the printed rules 412 comprising a pay table.

According to this embodiment, the dealer deals two cards to the dealer area 404 and two cards to each player area 402, face down. Dealer cards remain face down while the secondary game is being played. The two-card poker game is played first. The dealer reveals and examines the player hands and compares the hand ranking to the pay table of the printed rules 412 of winning hands and corresponding payout odds. If a predetermined winning hand is obtained, such as a straight flush, the dealer pays the player according to the odds posted in the pay table. In this example, the minimum ranking hand that is a winning hand is a straight or better. For a straight flush, the odds payout is 4:1. The amount wagered is multiplied by four to arrive at the payout amount. The amount wagered, the payout amount, part of the amount wagered, or part of the payout amount, or combinations thereof may be distributed to the player or may be added to the primary wager, at the option of the player. The dealer cards are not considered when resolving the secondary wager in this embodiment. If the player does not hold a predetermined winning two-card poker hand, the secondary wager is taken by the house, and play continues. In this embodiment, the secondary wager is mandatory.

If the player holds a winning two-card poker hand, the dealer must receive an election from the player to move all or part of the secondary wager and the secondary winnings to the primary wager area 408 or an election from the player to pay the player a payout. After all or part of the secondary wager and winnings is paid out or re-wagered, play continues. It is to be understood that, in some embodiments, the secondary wager is optional. In the event that a player elects not to make a secondary wager, the player will only play the primary wagering game, and the primary wagering game will be played first by that player. The dealer may receive secondary wagers from other players at the same table who may play the secondary game before the primary game.

In this example of the game, the primary wager 408 is made on a blackjack game. The players and dealer each receive a two-card hand. The player uses the same two cards used to resolve the secondary wager to resolve the primary wager. After the secondary two-card poker game is played, blackjack play continues, except that when the dealer is dealt a two-card blackjack, play ends for the players, and the players cannot move all or part of the secondary wager or proceeds from the secondary wager to the primary wager spot. The dealer deals players hit cards or receives elections to stand according to player requests, and the dealer takes hit cards and makes stand decisions according to house rules. For example, if the printed rules 410 for the primary wagering game include the requirement that the dealer hit on a soft 17, the dealer cannot deviate from this rule. The highest-ranking hand that does not exceed a point count of 21 wins the round. If the player beats the dealer with less than a blackjack, the player is paid 1:1. If the player has a blackjack and beats the dealer hand, the player is paid 3:2. Other blackjack rules, such as double downs, insurance bets, and card splitting, can be included as part of the rules of the primary game. The primary wager may be resolved using blackjack rules. In some embodiments of the present method, the secondary wager is optional. In other embodiments such as with one of the examples below, the secondary wager is mandatory.

Some players prefer to go “all in” and put all available wagers at risk. In this instance, examples of the present method would allow the player to move all amounts wagered and all amounts paid on the secondary wager to the primary wager position. Examples of the present embodiment may allow for more conservative betting, allowing the dealer to accept a wager that represents a portion of the secondary wager or the secondary winnings amount and combine that wager with the primary wager. In one embodiment, the dealer requires players that have won the secondary wager to put all of the secondary wager and secondary wager winnings amounts on the primary wager betting circle.

In other embodiments, the dealer can accept an election to put all or a portion of secondary wagers and payouts on another wager that was not offered in the primary game, such as a bet on the dealer hand or a tie.

### Three-Card Poker Against a Dealer Hand/Three-Card Poker Pay Table Game

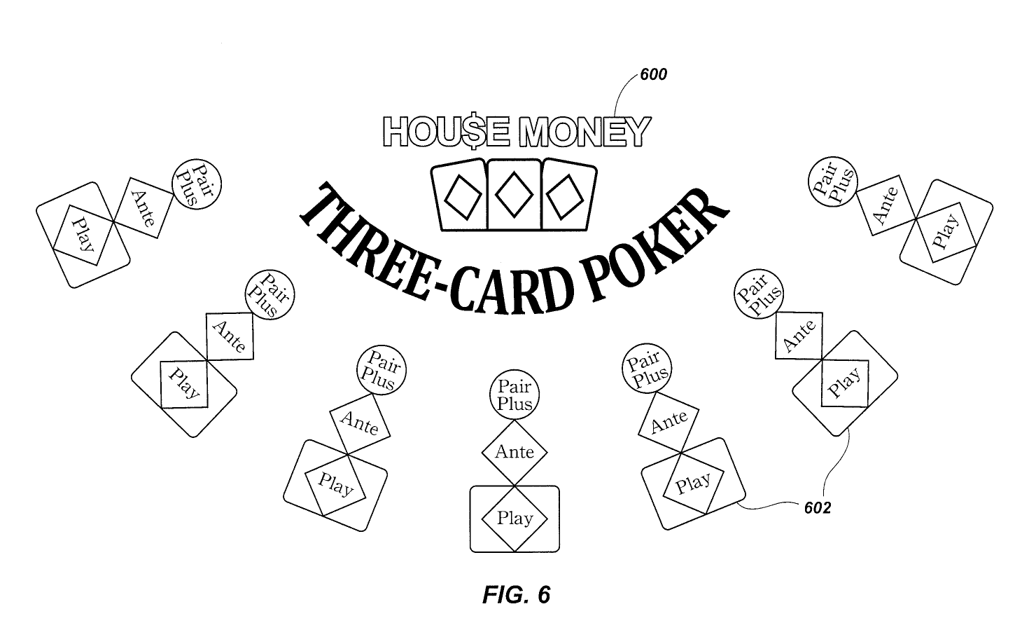

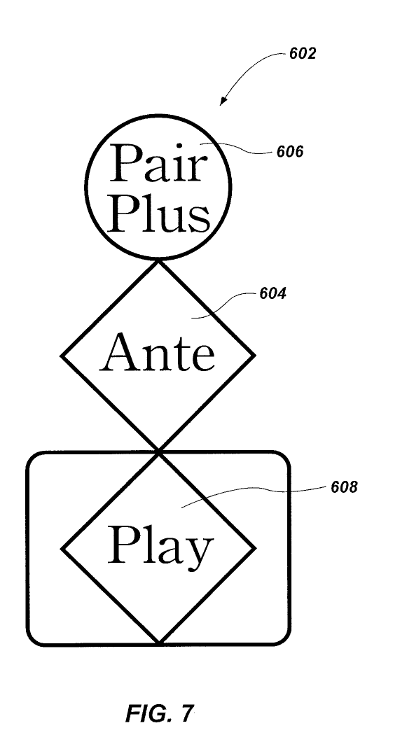

In another example of a method for administering a wagering game in accordance with the present disclosure, the primary game rules comprise dealing three cards to each player and to the dealer and comparing a point value of the player hands to the dealer hand, wherein three-card poker rankings are used to determine the winning hand. The game can be played on a suitable gaming table surface 600, as shown in FIG. 6. The gaming table surface 600 is provided with multiple player play areas 602. The secondary game rules is preferably played first and comprises the player playing a three-card poker game against a pay table of predetermined winning hands and corresponding payout odds. The dealer's cards remain face down on the table while the secondary wager is being played. FIG. 7 is an expanded view of a player play area 602. According to this example, the primary game is a three-card poker game against a dealer hand. The dealer may receive an ante wager from the player, the ante wager being the primary wager, and placed in an ante betting circle 604. When the secondary game is a three-card poker game against a pay table, the player can make a secondary “pair plus” wager on betting circle 606. In this example of the game, both the ante and pair plus wagers are mandatory, and the minimum winning hand on the pair plus wager is a pair or better. In other embodiments, other minimum hand rankings are the minimum winning ranking, such as a flush or better. In one embodiment, the player views his hand, and the dealer receives an election to either fold or make a play wager in betting circle 608. In one embodiment, the play wager is equal to the ante. In other examples, the play wager is a multiple of the ante.

In other examples (not shown), the dealer receives an election to make a play wager or check, and the player may not elect to fold. No further betting is needed when the dealer receives a check election from the player. In yet another example, the dealer does not receive an election from the player to keep the ante wager in play, and no further wagering to keep the ante in play is allowed under the rules.

The secondary wager (e.g., the “pair plus” wager placed in betting circle 606) is resolved first, before the dealer hand is revealed. If the player holds a predetermined winning hand, that wager is paid based on posted odds. The dealer then receives an election to either pay out all or portion of the winning pair plus wager and corresponding payouts or combine the wager with the primary ante wager (e.g., the wager placed in betting circle 604). If the player holds less than the predetermined minimum winning hand, the house takes the bet on betting circle 606 (i.e., the secondary “pair plus” wager).

The dealer then reveals the dealer hand. Player and dealer hands are compared and the dealer takes the ante (and play wager, if made) when the dealer hand outranks the player hand. The dealer pays the player a predetermined payout, such as 1:1 or 2:1 on the ante (and play wager, when made) when the player hand outranks the dealer hand, using standard three-card poker hand rankings. In some forms of the wagering game, the dealer hand must qualify, such as with a queen-high or better, otherwise the ante, the play wager, or both the play wager and the ante wager push. Alternatively, the ante or the play wager can push and the other bet (the play wager or the ante) can pay 1:1, depending on the desired house odds.

The secondary set of rules may comprise a three-card poker pay table, such as Pay Table I, above.

Automatic ante bonus odds payouts or fixed payout amounts for certain high-ranking hands, such as a straight or better, may also be paid.

In other embodiments, amounts wagered and won on the pair plus bet can be made on a wager not available in the primary game, such as a dealer hand or a tie hand.

In some embodiments, the wagering games described herein may be played against the house (i.e., be “house-banked”), which may involve playing against a dealer hand or a pay table, with payouts on wagers being paid by a casino or other gaming establishment and losses on wagers being collected by the casino or other gaming establishment. For example, in examples above, winnings on the secondary wagering game and winnings on the primary wagering game may be paid out by the casino or other gaming establishment and losses on the secondary wagering game and on the primary wagering game may be retained by the casino or other gaming establishment.

In other embodiments, the wagering games, or at least one wager associated with the wagering game, may enable players to play against one another (i.e., be “player-banked” or “player-pooled”), with payouts on wagers being paid from a pot and losses on wagers being collected by other players. Such methods may include accepting a primary wager from a player and adding the primary wager to a primary pot (e.g., a pool or accumulation of bets). The primary wager may include, for example, antes, blinds, play bets, raises, and other bets made on the underlying, primary wagering game. The primary wager may be accepted and the wagering game may be played only against other players in the wagering game, not against the house, in some embodiments. In some embodiments, a separate, mandatory secondary pot wager may be collected from each player participating in the game. The secondary pot wager may be a no house advantage bet that is awarded to the player holding the highest ranking hand in the round of play. Although the various pot bets for purposes of this disclosure are numbered (e.g., primary, secondary), the numbering is for purposes of illustration only. For example, the secondary pot may include the game wagers and the primary pot may be the no house advantage wagers.

In other embodiments, the primary wager may be accepted and the wagering game may be played against the house. The wagering game may comprise, for example, poker or a variant of poker (e.g., five card poker, three card poker, Mississippi Stud, Texas Hold 'em, or Caribbean Stud), or baccarat or a variant of baccarat, such as, for example, the game described previously in connection with FIG. 1. The wagers may be accepted by, for example, electronically accepting funds from a player account or other credit authorized via one or more communications media (e.g., via the Internet, wireless communications, land line) on a remote electronic device (e.g., a personal computer, a laptop, a tablet computer, or a smartphone) by player input, electronically accepting funds from a player account authorized on a local wagering game administration device in a casino by player input, or physically placing money or representations of money (e.g., chips) on a table at a live game in a casino. Suitable network architecture for electronically accepting funds from a player account authorized on a remote device may comprise, for example, the network gaming architecture disclosed in U.S. patent application Ser. No. 13/353,194, filed Jan. 18, 2012, to Costello et al., and U.S. patent application Ser. No. 13/609,031 filed Sep. 10, 2012 to Costello et al., the disclosures of which are incorporated herein in their entirety by this reference. Suitable local wagering game administration devices may comprise, for example, the chipless tables disclosed in U.S. Patent Application Pub. No. 2010/0016050, published Jan. 21, 2010, to Snow et al., the disclosure of which is incorporated herein in its entirety by this reference.

In some embodiments, wagering games may be played without risking money in connection with the wagers (i.e., “play-for-fun” games). Access to play-for-fun wagering games may be granted on a time period basis in some embodiments. For example, upon initially joining the wagering game, each player may automatically be given wagering elements, such as, for example, chips, points, or simulated currency, that is of no redeemable value. After joining, the player may be free to place bets using the wagering elements and a timer may track how long the player has been participating in the wagering game. If the player exhausts his or her supply of the wagering elements before a predetermined period of time has expired, the player may simply wait until the period of time passes to rejoin the game and receive another quantity of the wagering elements to resume participation in the wagering game.

In some embodiments, a hierarchy of players may determine the quantity of wagering elements given to a player for each predetermined period of time. For example, players who have been participating in the wagering game for a longer time, who have played closest to optimal strategy for the game, who have won the largest percentage of wagers, or who have won the largest quantities of wagering elements from their wagers may be given more wagering elements for each allotment of time than players who have newly joined, who have played according to poor strategy, who have lost more frequently, or who have lost larger quantities of wagering elements. In some embodiments, the hierarchy of players may determine the duration of each allotment of time. For example, players who have been participating in the wagering game for a longer time, who have played closest to optimal strategy for the game, who have won the largest percentage of wagers, or who have won the largest quantities of wagering elements from their wagers may be given shorter allotments of times to wait after exhausting their supply of wagering elements than players who have newly joined, who have played according to poor strategy, who have lost more frequently, or who have lost larger quantities of wagering elements. In some embodiments, players who have not run out of wagering elements after the period of time has expired may have the balance of their wagering elements reset for a subsequent allotment of time. In other embodiments, players who have not run out of wagering elements may retain their remaining wagering elements for subsequent allotments of time, and may receive additional wagering elements corresponding to the new allotment of time to further increase the balance of wagering elements at their disposal. Players may be assigned to different categories of players, which determine the number of wagering elements awarded. In a given period of time, higher level players, or players who have invested more time playing the game may earn more wagering elements per unit of time than a player assigned to a lower level group.

In some embodiments, a player may be permitted to redeem an access token of no redeemable face value, such as, for example, points associated with a player account (e.g., social media account credits, online points associated with a transacting account, etc.), to compress the period of time and receive more wagering elements. The access tokens may be purchased or may be obtained without directly exchanging money for the access tokens. For example, access tokens may be acquired by participating in member events (e.g., completing surveys, receiving training on how to play the wagering game, sharing information about the wagering game with others), spending time participating in the wagering game or in a player account forum (e.g., logged in to a social media account), or viewing advertising. Thus, an entity administering play-for-fun wagering games may not receive money from losing player wagers or may not take a rake on wagers, but may receive compensation through advertising revenue or through the purchase of access tokens redeemable for time compressions to continue play of the wagering game or simply to increase the quantity of wagering elements available to a player.

After a player has stopped participating in a play-for-fun wagering game, any remaining quantities of the wagering elements may be relinquished by the player in some embodiments. For example, logging out of a play-for-fun wagering game administered over the Internet may cause any remaining wagering elements associated with a respective player to be lost. Thus, when the player rejoins the play-for-fun wagering game, the quantity of wagering elements given to the player for an allotment of time may not bear any relationship to the quantity of wagering elements held by the player when he or she quit playing a previous session of the wagering game. In other embodiments, the quantity of wagering elements held by a player when stopping participation may be retained and made available to the player, along with any additional quantities of wagering elements granted for new allotments of time, when rejoining the wagering game.

### Other Game Formats

Various platforms are contemplated that are suitable for implementation of embodiments of wagering games according to the present disclosure. For example, embodiments of wagering games may be implemented such that one or more players may place wagers and engage in game play according to the rules of the wagering games. For example, wagering games may be implemented on gaming tables, which may include physical gaming features, such as physical cards and physical chips, and may include a live dealer and a shuffler or shoe. More specifically, a live dealer may deal physical cards, accept wagers, issue payouts, and perform other administrative functions of game play. Some embodiments may be implemented on electronic devices enabling electronic gaming features, such as providing electronic displays for display of virtual cards, virtual chips, game instructions, pay tables, etc. Some embodiments may include features that are a combination of physical and electronic features.

As an example, embodiments of wagering games may be implemented on an individual gaming device for accepting wagers that has a display screen and input devices for enabling game play of the wagering games. Such an individual gaming device may be linked with other gaming devices that may be operated, for example, by other players. Some individual electronic gaming devices may be referred to as an individual player “cabinet” and may be stationary, such as being located on a casino floor. Other individual electronic gaming devices may be portable devices that may be carried to different locations by the player. Portable devices may include both display of the ongoing game play and input reception for game play by a player, or, may be for receiving input from a player while the game play is displayed on a public monitor, or other display device. Game play and game outcomes may also be displayed on a portable device.

As previously noted, any of the present methods and games may be played as a live casino table card game, as a hybrid casino table card game (with virtual cards or virtual chips), on a multi-player electronic platform (as disclosed in U.S. patent application Ser. Nos. 10/764,827; 10/764,994 (now U.S. Pat. No. 7,661,676, issued Feb. 16, 2010); and 10/764,995, all filed on Jan. 26, 2004, the disclosure of each of which applications is incorporated herein in its entirety by this reference), on a personal computer for practice, on a hand-held game for practice or on a legally authorized site on the Internet.

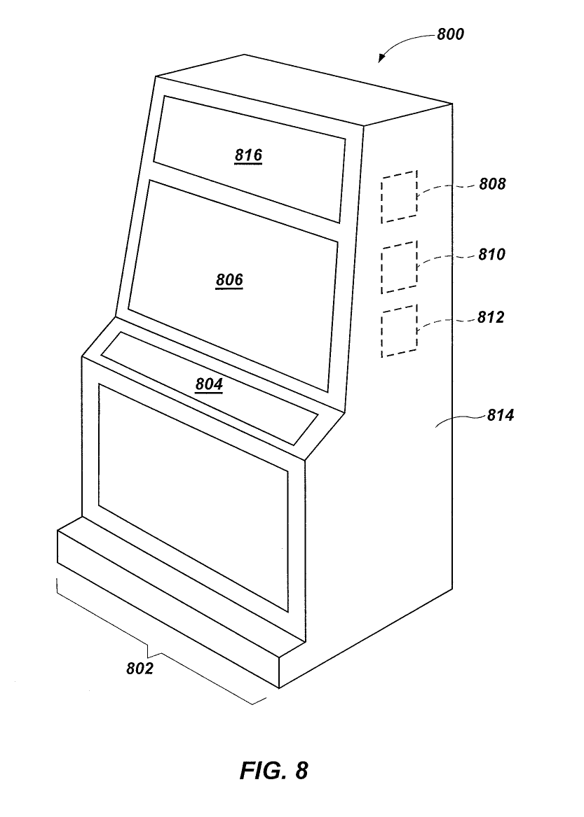

Referring to FIG. 8, an example of an individual electronic gaming device 800 (e.g., an electronic gaming machine (EGM)) configured for implementation of embodiments of wagering games according to the present disclosure is shown. The individual electronic gaming device 800 may include an individual player position 802 that includes a player input area 804 for a player to interact with the individual electronic gaming device 800 through various input devices (not shown). The individual electronic gaming device 800 may include a gaming screen 806 configured to display indicia for interacting with the individual electronic gaming device 800, such as through processing one or more stored programs in memory 808 to implement the rules of game play at the individual electronic gaming device 800. Accordingly, game play may be accommodated without involving physical playing cards, poker chips, and/or live personnel. The action may instead be simulated by a control processor 810 operably coupled to the memory 808 and interacting with and controlling the individual electronic gaming device 800.

Although the figure has an outline of a traditional gaming cabinet, the individual electronic gaming device 800 may be implemented in any number of ways including, but not limited to, client software downloaded to a portable device, such as a smart phone, tablet, or laptop personal computer. The individual electronic gaming device 800 may also be a non-portable personal computer (e.g., a desktop or all-in-one computer) or other computing device. In some embodiments, client software is not downloaded but is native to the device or is otherwise delivered with the device when received by a player.

A communication device 812 may be included and operably coupled to the processor such that information related operation of the gaming device 800, information related to the game play, or combinations thereof may be communicated between the gaming device 800 and other devices (not shown) through a suitable communication media, such as, for example, wired networks, Wi-Fi networks, and cellular communication networks.

The gaming screen 806 may be carried by a generally vertically extending cabinet 814 of the individual electronic gaming device 800. The individual electronic gaming device 800 may further include banners (not shown) configured to communicate rules of game play and/or the like, such as along a top portion 816 of the cabinet 814 of the individual electronic gaming device 800. The individual electronic gaming device 800 may further include additional decorative lights (not shown) and speakers (not shown) for transmitting and/or receiving sounds during game play. Further detail of an example of an individual electronic gaming device 800 (as well as other embodiments of tables and devices) is disclosed in U.S. patent application Ser. No. 13/215,156, filed Aug. 22, 2011, published as U.S. Patent Publication No. 2013/0053117 on Feb. 28, 2013, and titled “Methods of Managing Play of Wagering Games and Systems for Managing Play of Wagering Games,” the disclosure of which is incorporated herein in its entirety by this reference.

Some embodiments may be implemented at locations that include a plurality of player stations. Such player stations may include an electronic display screen for display of game information, such as displaying virtual cards, virtual chips, and game instructions, and for accepting wagers and facilitating credit balance adjustments. Such player stations may, optionally, be integrated in a table format, may be distributed throughout a casino or other gaming site, or may be include both grouped and distributed player stations. While some features may be automated through electronic interfaces (e.g., virtual cards, virtual chips, etc.), some features may remain in the physical domain. As such, the game play may be administered by a live dealer, a virtual dealer, or a combination of both.

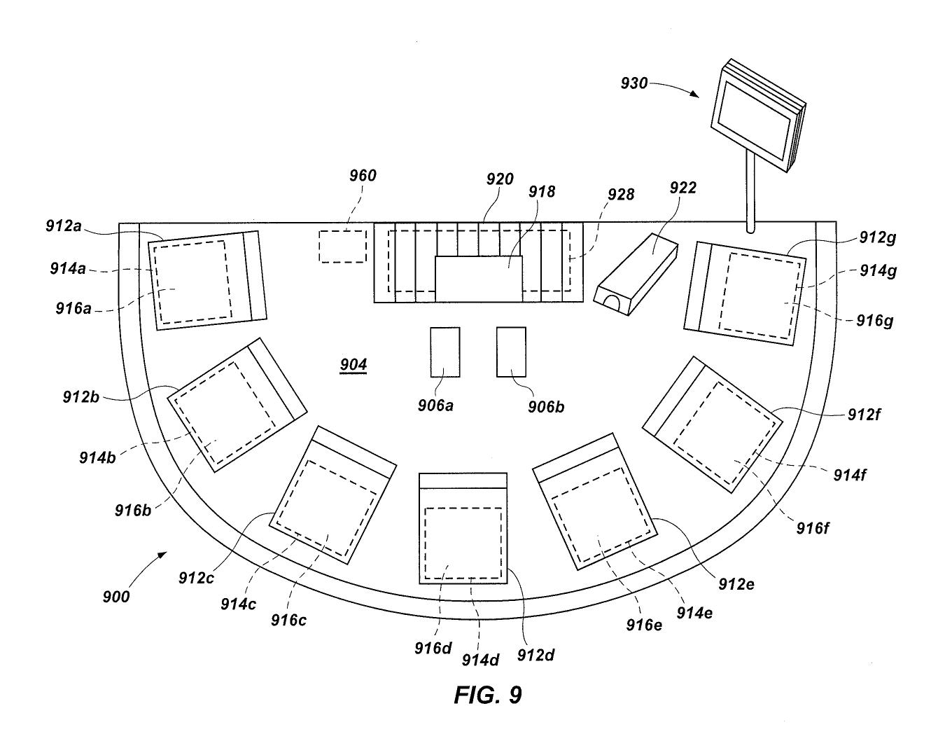

Referring to FIG. 9, an example of a suitable table 900 configured for implementation of embodiments of wagering games according to the present disclosure is shown. The table 900 may include a playing surface 904. The table 900 may include a plurality of player stations 912a through 912g. Each player station 912a through 912g may include a player interface 916a through 916g, which may be used for display of game information (e.g., game instructions, input options, wager information including virtual chips, game outcomes, etc.). The player interface 916a through 916g may include a display screen in the form of a touch screen, which may be at least substantially flush with the playing surface 904 in some embodiments. Each player interface 916a through 916g may be coupled respectively with its own local game processor 914a through 914g (shown in dashed lines), although in some embodiments, a central game processor 928 (shown in dashed lines) may be employed and communicate directly to player interfaces 916a through 916g. In some embodiments, a combination of individual local game processors 914a through 914g and the central game processor 928 may be employed.

A communication device 960 may be included and operably coupled to one or more of the local processors 914, the central game processor 928, or combinations thereof, such that information related to operation of the table 900, information related to the game play, or combinations thereof may be communicated between the table 900 and other devices (not shown) through a suitable communication media, such as, for example, wired networks, Wi-Fi networks, and cellular communication networks.

The table 900 may further include additional features, such as a dealer chip tray 920, which may be used by the dealer to cash players in and out of the wagering game, whereas wagers and balance adjustments during game play may be performed using virtual chips. For embodiments using physical cards 906a, 906b, the table 900 may further include a card-handling device 922 that may be configured to shuffle, read, and deliver physical cards for the dealer and players to use during game play or, alternatively, a card shoe configured to read and deliver cards that have already been randomized. For embodiments using virtual cards, such virtual cards may be displayed at the individual player interfaces 916a through 916g. Common virtual cards may be displayed in a common card area (not shown).

The table 900 may further include a dealer interface 918, which, like the player interfaces 916a through 916g, may include touch screen controls for assisting the dealer in administering the wagering game. The table 900 may further include an upright display 930 configured to display images that depict game information such as pay tables, hand counts, historical win/loss information by player, and a wide variety of other information considered useful to the players. The upright display 930 may be double sided to provide such information to players as well as to the casino pit.

Further detail of an example of a table and player displays is disclosed in U.S. Patent Application Publication No. 2010/0016050, published Jan. 21, 2010, now U.S. Pat. No. 8,262,475, issued Sep. 11, 2012, and now titled “Chipless Table Split Screen Feature,” the disclosure of which is incorporated herein in its entirety by this reference. Although an embodiment is described showing individual discrete player stations, in some embodiments, the entire playing surface 904 may be an electronic display that is logically partitioned to permit game play from a plurality of players for receiving inputs from, and displaying game information to, the players, the dealer, or both.

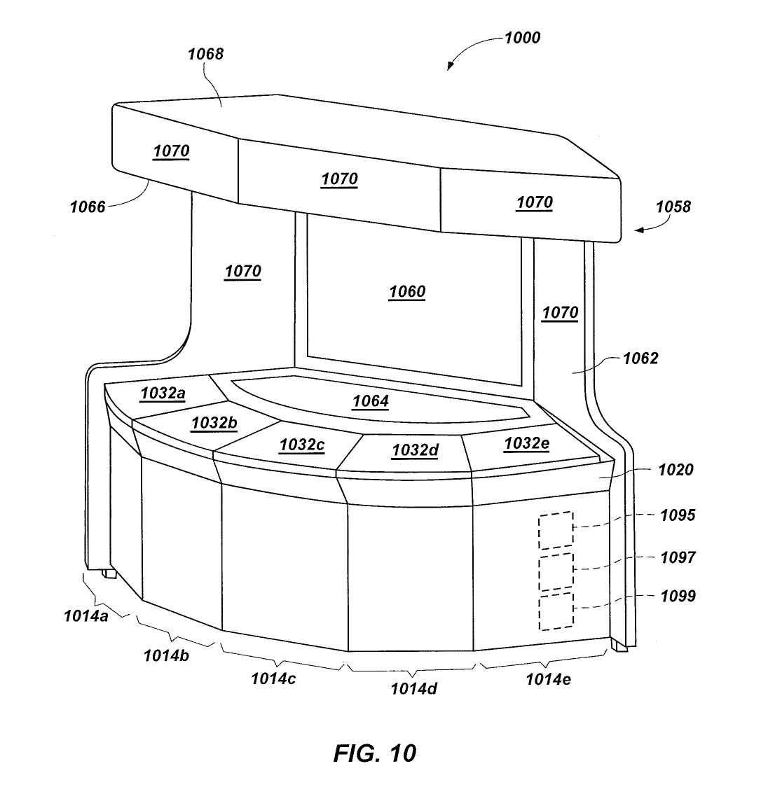

Referring to FIG. 10, another example of a suitable table 1000 configured for implementation of embodiments of wagering games having a virtual dealer according to the present disclosure is shown. The table 1000 may include player positions 1014a through 1014e that are arranged in a bank about an arcuate edge 1020 of a video device 1058 that may comprise a card screen 1064 and a dealer screen 1060. The dealer screen 1060 may display a video simulation of the dealer (i.e., a virtual dealer) for interacting with the video device 1058, such as through processing one or more stored programs stored in memory 1095 to implement the rules of game play at the video device 1058. The dealer screen 1060 may be carried by a generally vertically extending cabinet 1062 of the video device 1058. The card screen 1064 may be configured to display at least one or more of the dealer's cards, community cards, and/or player's cards by the virtual dealer on the dealer screen 1060 (virtual dealer not shown in FIG. 10).

Each of the player positions 1014a through 1014e may include a player interface area 1032a through 1032e that is configured for wagering and game play interactions with the video device 1058 and/or virtual dealer. Accordingly, game play may be accommodated without involving physical playing cards, poker chips, and/or live personnel. The action may instead be simulated by a control processor 1097 interacting with and controlling the video device 1058. The control processor 1097 may be located internally within, or otherwise proximate to, the video device 1058. The control processor 1097 may be programmed, by known techniques, to implement the rules of game play at the video device 1058. As such, the control processor 1097 may interact and communicate with display/input interfaces and data entry inputs for each player interface area 1032a through 1032e of the video device 58. Other embodiments of tables and gaming devices may include a control processor that may be similarly adapted to the specific configuration of its associated device.

A communication device 1099 may be included and operably coupled to the control processor 1097 such that information related to operation of the table 1000, information related to the game play, or combinations thereof may be communicated between the table 1000 and other devices (not shown) through a suitable communication media, such as, for example, wired networks, Wi-Fi networks, and cellular communication networks.

The video device 1058 may further include banners (not shown) configured to communicate rules of play and/or the like, which may be located along one or more walls 1070 of the cabinet 1062. The video device 1058 may further include additional decorative lights (not shown) and speakers (not shown), which may be located on an underside surface 1066, for example, of a generally horizontally depending top 1068 of the cabinet 1062 of the video device 1058 generally extending toward the player positions 1014a through 1014e.

Further detail of an example of a table and player displays is disclosed in U.S. Patent Application Publication No. 2005/0164762, published Jul. 28, 2005, now U.S. Pat. No. 8,272,958, issued Sep. 25, 2012, and titled “Automated Multiplayer Game table with Unique Image Feed of Dealer,” the disclosure of which is incorporated herein in its entirety by this reference. Although an embodiment is described showing individual discrete player stations, in some embodiments, the entire playing surface (e.g., player interface areas 1032a through 1032e, card screen 1064, etc.) may be an electronic display that is logically partitioned to permit game play from a plurality of players for receiving inputs from, and displaying game information to, the players, the dealer, or both.

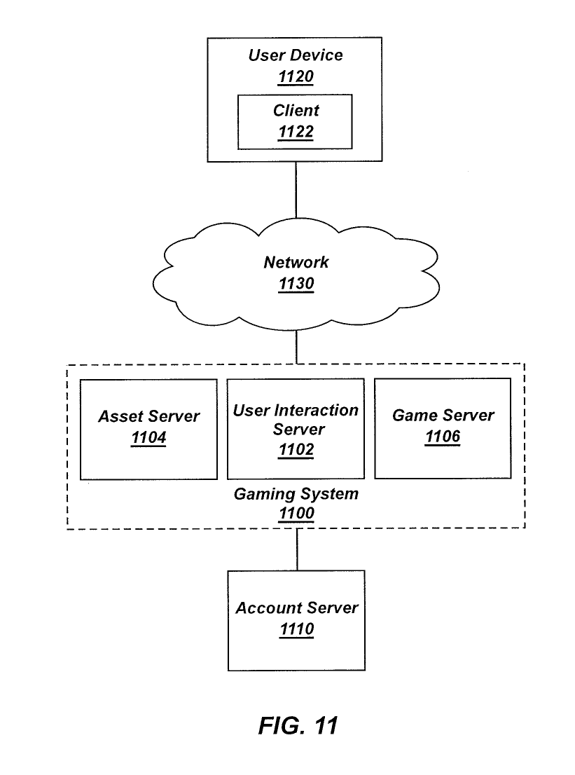

Wagering games in accordance with embodiments of the disclosure may be administered over the Internet, or otherwise online, in one embodiment using a gaming system employing a client server architecture. Referring to FIG. 11, a schematic block diagram of a gaming system 1100 for implementing wagering games according to an embodiment is shown. The gaming system 1100 enables end users to access proprietary and/or non-proprietary game content. Such game content may include, without limitation, various types of wagering games such as card games, dice games, big wheel games, roulette, scratch off games (“scratchers”), and any other wagering game where the game outcome is determined, in whole or in part, by one or more random events. This includes, but is not be limited to, Class II and Class III games as defined under 25 U.S.C. §2701 et seq. (“Indian Gaming Regulatory Act”). Such games may include banked and/or non-banked games.

The wagering games supported by the gaming system 1100 may be operated with real currency or with virtual credits or other virtual (e.g., electronic) value indicia. For example, the real currency option may be used with traditional casino and lottery-type wagering games in which money or other items of value are wagered and may be cashed out at the end of a game session. The virtual credits option may be used with wagering games in which credits (or other symbols) may be issued to a player to be used for the wagers. A player may be credited with credits in any way allowed, including, but not limited to, a player purchasing credits; being awarded credits as part of a contest or a win event in this or another game (including non-wagering games); being awarded credits as a reward for use of a product, casino, or other enterprise, time played in one session, or games played; or may be as simple as being awarded virtual credits upon logging in at a particular time or with a particular frequency, etc. Although credits may be won or lost, the ability of the player to cash out credits may be controlled or prevented. In one example, credits acquired (e.g., purchased or awarded) for use in a play-for-fun game may be limited to non-monetary redemption items, awards, or credits usable in the future or for another game or gaming session. The same credit redemption restrictions may be applied to some or all of credits won in a wagering game as well.

An additional variation includes web-based sites having both play-for-fun and wagering games, including issuance of free (non-monetary) credits usable to play the play-for-fun games. This may attract players to the site and to the games before they engage in wagering. In some embodiments, a limited number of free or promotional credits may be issued to entice players to play the games. Another method of issuing credits includes issuing free credits in exchange for identifying friends who may want to play. In another embodiment, additional credits may be issued after a period of time has elapsed to encourage the player to resume playing the game. The gaming system 1100 may enable players to buy additional game credits to allow the player to resume play. Objects of value may be awarded to play-for-fun players, which may or may not be in a direct exchange for credits. For example, a prize may be awarded or won for a highest scoring play-for-fun player during a defined time interval. All variations of credit redemption are contemplated, as desired by game designers and game hosts (the person or entity controlling the hosting systems).

The gaming system 1100 may include a gaming platform that establishes a portal for an end user to access a wagering game hosted by a game server 1106 through a user interaction server 1102. A user device 1120 may communicate with the user interaction server 1102 of the gaming system 1100 using a network 1130 (e.g., the Internet). The user interaction server 1102 may communicate with the game server 1106 and provide game information to the user. In some embodiments, the game server 1106 may also be a game engine. In some embodiments, a single user device communicates with a game provided by the game server 1106, while other embodiments may include a plurality of user devices 1120 configured to communicate and provide end users with access to the same game provided by game server 1106. In addition, a plurality of end users may access a single user interaction server 1102, or, a plurality of user interaction servers 1102 to access the game server 1106.

The user interaction server 1102 may communicate with the user device 1120 to enable access to the gaming system 1100. The user interaction server 1102 may enable a user to create and access a user account and interact with the game server 1106. The user interaction server 1102 may enable users to initiate new games, join existing games, and interface with games being played by the user.

The user interaction server 1102 may also provide a client 1122 for execution on the user device 1120 for accessing the gaming system 1100. The client 1122 provided by the gaming system 1100 for execution on the user device 1120 can comprise a variety of implementations according to the user device 1120 and method of communication with the gaming system 1100. In one embodiment, the user device 1120 connects to the gaming system 1100 using a web browser, and the client 1122 executes within a browser window or frame of the web browser. In another embodiment, the client 1122 is a stand-alone executable on the user device 1120.

In one embodiment, the client 1122 may comprise a relatively small amount of script (e.g., JAVASCRIPT®), also referred to as a “script driver,” including scripting language that controls an interface of the client 1122. The script driver may include simple function calls requesting information from the gaming system 1100. In other words, the script driver stored in the client 1122 may merely include calls to functions that are externally defined by, and executed by, the gaming system 1100. As a result, the client 1122 may be characterized as a “thin client.” As that term is used herein, the client 1122 may be little more than a script player. The client 1122 may simply send requests to the gaming system 1100 rather than performing logic itself. The client 1122 receives player inputs, and the player inputs are passed to the gaming system 1100 for processing and executing the wagering game. In one embodiment, this includes providing specific graphical display information to the client 1122 as well as game outcomes.

In other embodiments, the client 1122 comprises an executable file rather than a script. In such case, the client 1122 may do more local processing than does a script driver, such as calculating where to show what game symbols upon receiving a game outcome from game server 1106 through user interaction server 1102. In one embodiment, it may be that portions of an asset server 1104 are loaded onto the client 1122 and are used by the client 1122 in processing and updating graphical displays. Due to security and integrity concerns, most embodiments will have the bulk of the processing of the game play performed in the gaming system 1100. However, some embodiments may include significant game processing by the client 1122 when the client 1122 and the user device 1120 are considered trustworthy, or, when there is reduced concern for security and integrity in the displayed game outcome. In most embodiments, it is expected that some form of data protection, such as end-to-end encryption, will be used when data is transported over the network 1130. The network 1130 may be any network, including, but not limited to, the Internet.

In an embodiment where the client 1122 implements further logic and game control methodology beyond the thin client, the client 1122 may parse and define player interactions prior to passing the player interactions to the gaming system 1100. Likewise, when the client 1122 receives a gaming interaction from the gaming system 1100, the client 1122 may be configured to determine how to modify the display as a result of the gaming interaction. The client 1122 may also allow the player to change a perspective or otherwise interact with elements of the display that do not change aspects of the game.

The gaming system 1100 may include the asset server 1104, which may host various media assets (e.g., audio, video, and image files) that may be sent to the client 1122 for presenting the various wagering games to the end user. In other words, in this embodiment, the assets presented to the end user may be stored separately from the client 1122. In one embodiment, the client 1122 requests the assets appropriate for the game played by the user; in other embodiments, especially those using thin clients, just those assets that are needed for a particular display event will be sent by the game server 1106 when the game server 1106 determines they are needed, including as few as one asset. In one example, the client 1122 may call a function defined at the user interaction server 1102 or the asset server 1104, which may determine which assets are to be delivered to the client 1122 as well as how the assets are to be presented by the client 1122 to the end user. Different assets may correspond to the various clients that may have access to the game server 1106 or to different games to be played.

The game server 1106 is configured to perform game play methods and determine game play outcomes that are provided to the user interaction server 1102 to be transmitted to the user device 1120 for display on the end user's computer. For example, the game server 1106 may include game rules for one or more wagering games, such that the game server 1106 controls some or all of the game flow for a selected wagering game, as well as the determined game outcomes. The game server 1106 may include pay tables and other game logic. The game server 1106 also performs random number generation for determining random game elements of the wagering game. In one embodiment, the game server 1106 is separated from the user interaction server 1102 by a firewall or other method of preventing unauthorized access to the game server 406 from the general members of the network 1130.

The user device 1120 may present a gaming interface to the player and communicate the user interaction to the gaming system 1100. The user device 1120 may be any electronic system capable of displaying gaming information, receiving user input, and communicating the user input to the gaming system 1100. As such, the user device 1120 can be a desktop computer, a laptop, a tablet computer, a set-top box, a mobile device (including, but not limited to, a smart phone), a kiosk, a terminal, or another computing device. The user device 1120 operating the client 1122 may comprise an individual electronic gaming device 800 (see FIG. 8), as described above. The client 1122 may be a specialized application or may be executed within a generalized application capable of interpreting instructions from an interactive gaming system, such as a web browser.

The client 1122 may interface with an end user through a web page or an application that runs on a device including, but not limited to, a smartphone, a tablet, or a general computer, or the client 1122 may be any other computer program configurable to access the gaming system 1100. The client 1122 may be illustrated within a casino webpage (or other interface) indicating that the client 1122 is embedded into a webpage, which is supported by a web browser executing on the client device 1120.

In one embodiment, the gaming system 1100 may be operated by different entities. The user device 1120 may be operated by a third party, such as a casino or an individual, that links to the gaming system 1100, which may be operated, for example, by a wagering game service provider. Therefore, in some embodiments, the user device 1120 and client 1122 may be operated by a different administrator than the operator of the game server 1106. In other words, the user device 1120 may be part of a third-party system that does not administer or otherwise control the gaming system 1100 or game server 1106. In another embodiment, the user interaction server 1102 and asset server 1104 are provided by a third-party system. For example, a gaming entity (e.g., a casino) may operate the user interaction server 1102 or user device 1120 to provide its customers access to game content managed by a different entity that may control the game server 1106, amongst other functionality. In some embodiments, these functions are operated by the same administrator. For example, a gaming entity (e.g., a casino) may elect to perform each of these functions in-house, such as providing both the access to the user device 1120 and the actual game content and providing administration of the gaming system 1100.

The gaming system 1100 may communicate with one or more external account servers 1110, optionally through another firewall. For example, the gaming system 1100 itself may not directly accept wagers or issue payouts. That is, the gaming system 1100 may facilitate online casino gaming but may not be part of a self-contained online casino itself. Instead, the gaming system 1100 may facilitate the play of wagering games owned and controlled by a company offering games and gaming products and services, such as SHFL entertainment, Inc. Another entity (e.g., a casino or any account holder or financial system of record) may operate and maintain its external account servers 1110 to accept bets and make payout distributions. The gaming system 1100 may communicate with the account servers 1110 to verify the existence of funds for wagering and instruct the account server 1110 to execute debits and credits.

In some embodiments, the gaming system 1100 may directly accept bets and make payout distributions, such as in the case where an administrator of the gaming system 1100 operates as a casino. As discussed above, the gaming system 1100 may be integrated within the operations of a casino rather than separating out functionality (e.g., game content, game play, credits, debits, etc.) among different entities. In addition, for play-for-fun wagering games, the gaming system 1100 may issue credits, take bets, and manage the balance of the credits according to the game outcomes, but the gaming system 1100 may not permit payout distributions or be linked to the account server 1110 that permits payout distributions. Such credits may be issued for free, through purchase, or for other reasons, without the ability for the player to cash out. Such play-for-fun wagering games may be played on platforms that do not permit traditional gambling, such as to comply with jurisdictions that do not permit online gambling.

The gaming system 1100 may be configured in many ways, from a fully integrated single system to a distributed server architecture. The asset server 1104, the user interaction server 1102, the game server 1106, and the account server 1110 may be configured as a single, integrated system of code modules running on a single server or machine, where each of the servers is functionality implemented on a single machine. In such a case, the functionality described herein may not be implemented as separate code modules. The asset server 1104, the user interaction server 1102, the game server 1106, and the account server 1110 may also be implemented as a plurality of independent servers, each using its own code modules running on a separate physical machine, and may further include one or more firewalls between selected servers (depending on security needs). Each server could communicate over some kind of networked connection, potentially as varied as that described for the network 1130. Further, each single server shown in FIG. 11 may be implemented as a plurality of servers with load balancing and scalability factors built into the embodiment. All such embodiments and variations are fully contemplated.

Additional features may be supported by the game server 1106, such as hacking and cheating detection, data storage and archival, metrics generation, messages generation, output formatting for different end user devices, as well as other features and operations. For example, the gaming system 1100 may include additional features and configurations as described in U.S. patent application Ser. No. 13/353,194, filed Jan. 18, 2012, and application Ser. No. 13/609,031, filed Sep. 10, 2012, both titled “Network Gaming Architecture, Gaming Systems, and Related Methods,” the disclosures of which are incorporated herein in their entirety by this reference.

The network 1130 may enable communications between the user device 1120 and the gaming system 1100. A network (not shown) may also connect the gaming system 1100 and account server 1110, and, further, one or more networks (not shown) may interconnect one or more of the other servers shown collectively as the gaming system 1100. In one embodiment, the network 1130 uses standard communications technologies and/or protocols. Thus, the network 1130 can include links using technologies such as Ethernet, 802.11, worldwide interoperability for microwave access (WiMAX), 3 G, digital subscriber line (DSL), asynchronous transfer mode (ATM), INFINIBAND®, PCI Express Advanced Switching, etc. Similarly, the networking protocols used on the network 1130 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 1130 can be represented using technologies and/or formats including the hypertext markup language (HTML), the extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc. In another embodiment, the entities can use custom and/or dedicated data communications technologies instead of, or in addition to, the ones described above. Depending upon the embodiment, the network 1130 can include links comprising one or more networks such as the Internet.

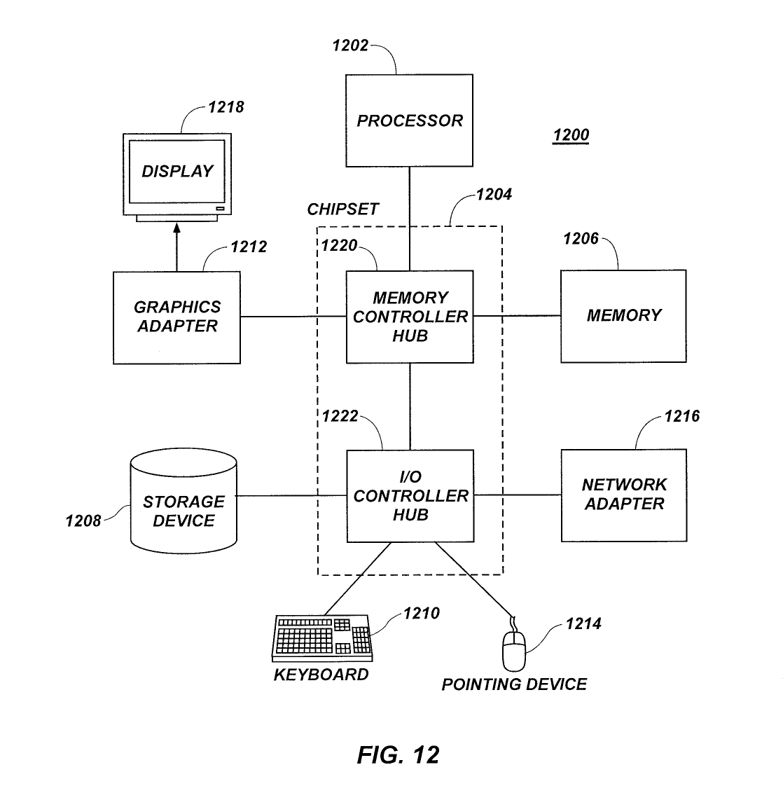

Referring to FIG. 12, a high-level block diagram of a computer system 1200 for acting as the gaming system 1100 (see FIG. 11) according to one embodiment is shown. Illustrated are at least one processor 1202 coupled to a chipset 1204, as indicated by dashed lines. Also coupled to the chipset 1204 are memory 1206, a storage device 1208, a keyboard 1210, a graphics adapter 1212, a pointing device 1214, and a network adapter 1216. A display 1218 is coupled to the graphics adapter 1212. In one embodiment, the functionality of the chipset 1204 is provided by a memory controller hub 1220 and an I/O controller hub 1222. In another embodiment, the memory 1206 is coupled directly to the processor 1202 instead of to the chipset 1204.

The storage device 1208 is any non-transitory computer-readable storage medium, such as a hard drive, a compact disc read-only memory (CD-ROM), a DVD, or a solid-state memory device (e.g., a flash drive). The memory 1206 holds instructions and data used by the processor 1202. The pointing device 1214 may be a mouse, a track pad, a track ball, or another type of pointing device, and it is used in combination with the keyboard 1210 to input data into the computer system 1200. The graphics adapter 1212 displays images and other information on the display 1218. The network adapter 1216 couples the computer system 1200 to a local or wide area network.

As is known in the art, a computer system can have different and/or other components than those shown in FIG. 12. In addition, the computer system 1200 can lack certain illustrated components. In one embodiment, the computer system 1200 acting as the gaming system 1100 (FIG. 11) lacks the keyboard 1210, pointing device 1214, graphics adapter 1212, and/or display 1218. Moreover, the storage device 1208 can be local and/or remote from the computer system 1200 (such as embodied within a storage area network (SAN)). Moreover, other input devices, such as, for example, touch screens, may be included.

The network adapter 1216 (may also be referred to herein as a communication device) may include one or more devices for communicating using one or more of the communication media and protocols discussed above with respect to FIG. 11.

In addition, some or all of the components of this general computer system 1200 of FIG. 12 may be used as part of the processor and memory discussed above with respect to the systems of FIGS. 8, 9, and 10.

The gaming system 1100 (FIG. 11) may comprise several such computer systems 1200. The gaming system 1100 may include load balancers, firewalls, and various other components for assisting the gaming system 1100 to provide services to a variety of user devices.

As is known in the art, the computer system 1200 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 1208, loaded into the memory 1206, and executed by the processor 1202.

Embodiments of the entities described herein can include other and/or different modules than the ones described here. In addition, the functionality attributed to the modules can be performed by other or different modules in other embodiments. Moreover, this description occasionally omits the term “module” for purposes of clarity and convenience.

Some portions of the detailed description are presented in terms of algorithms (e.g., as represented in flowcharts, prose descriptions, or both) and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic, or optical signals capable of being stored, transferred, combined, compared, and otherwise manipulated. It is convenient at times, principally for reasons of common usage, to refer to these signals as bits, values, elements, symbols, characters, terms, numbers, or the like. Furthermore, it is also convenient at times to refer to certain arrangements of steps requiring physical manipulations or transformation of physical quantities or representations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing,” “computing,” “calculating,” “determining,” “displaying,” “determining,” or the like, refer to the action and processes of a computer system, or similar electronic computing device (such as a specific computing machine), that manipulates and transforms data represented as physical (electronic) quantities within the computer system memories or registers or other such information storage, transmission, or display devices.

Certain aspects of the embodiments include process steps and instructions described herein in the form of an algorithm. It should be noted that the process steps and instructions of the embodiments can be embodied in software, firmware, or hardware, and, when embodied in software, could be downloaded to reside on and be operated from different platforms used by a variety of operating systems. The embodiments can also be in a computer program product that can be executed on a computing system.

Some embodiments also relate to an apparatus for performing the operations herein. Such an apparatus may be specially constructed for the purposes, e.g., a specific computer, or it may comprise a general-purpose computer selectively activated or reconfigured by a computer program stored in the computer. Such a computer program may be stored in a computer-readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions and each coupled to a computer system bus. Memory can include any of the above and/or other devices that can store information/data/programs and can be transient or non-transient medium, where a non-transient or non-transitory medium can include memory/storage that stores information for more than a minimal duration. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the method steps. The structure for a variety of these systems will appear from the description herein. In addition, the embodiments are not described with reference to any particular programming language. It will be appreciated that a variety of programming languages may be used to implement the teachings of the embodiments as described herein, and any references herein to specific languages are provided for the purposes of enablement and best mode.

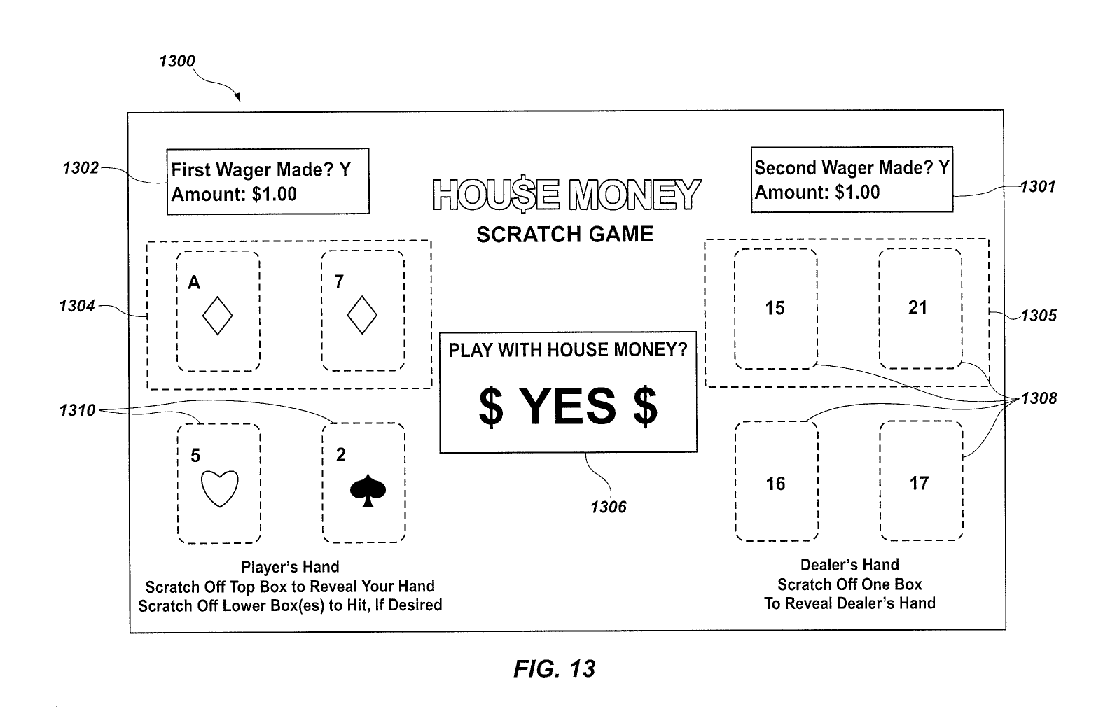

With reference to FIG. 13, a schematic of a wagering game implemented as a scratch card 1300 as an on-line game or lottery-type scratch ticket is shown. A player may purchase a physical scratch card 1300 or may access a virtually displayed scratch card 1300. In some embodiments, a verification code 1302 may be displayed (e.g., printed) on the scratch card 1300 to indicate whether or not a player made the first wager and optionally the amount of the first wager, for example, where the amount of the first wager is not fixed by the seller. The player may optionally make a secondary wager 1301. In other embodiments, a portion of the purchase price of the scratch card 1300 may be mandatorily allocated between the primary wager and the secondary wager. For example, 33% of the purchase price may be allocated to the primary wager and 67% of the purchase price may be allocated to the secondary wager.

In some embodiments, the player may then scratch off an opaque covering over an area 1304 to reveal individual images of cards that may be said to have been dealt to the player. In other embodiments, the player may scratch off individual opaque coverings over distinct areas 1305 of a virtual scratch card 1300 to reveal two images of cards that may be said to have been dealt to the dealer. Such scratching off, and other scratching described below, may involve scraping physical opaque coverings from a physical scratch card 1300 or may involve digitally concealing and subsequently digitally revealing (e.g., displaying a blank area and subsequently displaying card values in that area) electronic images on an electronic image of the scratch card 1300. If the rank of the cards dealt to the player constitutes a pair, for example, then the secondary wager is resolved in the player's favor. In some embodiments, such secondary game rules for resolving the secondary wager may be displayed on the scratch card 1300. If the suit and rank of cards dealt to the player do not constitute a winning two-card poker hand, the player loses at least the amount of the secondary wager. If the player made a secondary wager on the occurrence of a dealer pair, the cards 15, 21 in area 1305 would be revealed to check for the presence of a pair.

In some embodiments, the player may select whether to risk or keep winnings from the secondary wager (and optionally the amount of the secondary wager itself) at the time of purchase, and the player's selection may be displayed (e.g., printed) using another verification code 1306 on the scratch card 1300. In other embodiments, a player may indicate whether he would like to keep or to risk an entire amount of the winnings (optionally including the secondary wager) by scratching off an appropriate label, one label to retain them and another label to add them to the primary wager. In such embodiment, the scratch card 1300 may require supervision to ensure that a player scratches off the labels in the proper order (i.e., after scratching off the appropriate area 1304 or areas for the player's cards and before scratching off any other areas 1308 for the dealer's cards).

In some embodiments, the player may then scratch one of a plurality of other opaque coverings over a plurality of other areas 1308 (e.g., three, four, five, etc., other areas) to reveal individual total combined card rankings of cards that may be said to have been dealt to the dealer. In other embodiments, the player may scratch off a single opaque covering over an area of the scratch card 1300 to reveal two images of cards that may be said to have been dealt to the dealer or may scratch off two opaque coverings over two areas among a plurality of areas to reveal two individual cards that may be said to have been dealt to the dealer. In some embodiments, the scratch card 1300 may comprise additional opaque coverings over additional areas 1310 (e.g., two, three, four, five, etc., additional areas) to reveal individual hit cards that may be said to have been dealt to the player. Such a configuration may enable a player to make and resolve the first wager using only the cards in the area 1304, to evaluate the dealer's hand, and to elect to stand using only the cards in the area 1304 or to hit and play with one or more of the additional cards in the additional areas 1310. If the combined rank of the player's cards is greater than the combined rank of the dealer's cards according to the rules of blackjack, without exceeding twenty-one, for example, or according to the rules of baccarat, for example, then the primary wager is resolved in the player's favor. The player may redeem the scratch card 1300 for the appropriate amount of winnings. If the combined rank of the player's cards is less than the combined rank of the dealer's cards, then the scratch card 1300 may only be redeemed for value in embodiments where the player won the secondary wager and elected to keep the winnings from the secondary wager (and optionally the secondary wager itself).

Additional, non-limiting embodiments include:

### Embodiment 1

A method of administering a wagering game, comprising: accepting from a player a primary wager on a primary wagering game to be performed in accordance with primary game rules; accepting from the player a secondary wager on a secondary wagering game to be performed in accordance with secondary game rules; dealing cards to a player hand and to a banker hand; resolving the secondary wager based at least in part on dealt cards and in accordance with the secondary game rules; for winning outcomes on the secondary wager, allocating a secondary payout in accordance with received instructions directing allocation of the secondary payout amongst an allocation group comprising the player, the primary wager, and another primary wager; and resolving wagers on the primary wagering game based at least in part on the dealt cards and in accordance with the primary game rules, comprising: resolving the primary wager including any allocation from the secondary payout allocated toward the primary wager; and resolving any other allocation from the secondary payout allocated toward the another primary wager.

### Embodiment 2

The method of Embodiment 1, wherein allocating a secondary payout in accordance with received instructions directing allocation of the secondary payout amongst an allocation group comprising the player, the primary wager, and the another primary wager comprises: allocating a portion of the secondary payout to one of the allocation group; and allocating another portion of the secondary payout to another of the allocation group.

### Embodiment 3

The method of any one of Embodiments 1 and 2, wherein accepting from a player a primary wager on a primary wagering game to be performed in accordance with primary game rules comprises accepting from the player the primary wager designated for a primary outcome selected from a tie outcome and a hand win outcome, the tie outcome to be based on both the player hand and the banker hand, and the hand win outcome to be based on a primary designated hand selected from the player hand and the banker hand.

### Embodiment 4

The method of Embodiment 3, wherein accepting from the player a secondary wager on a secondary wagering game to be performed in accordance with secondary game rules comprises accepting from the player the secondary wager designated for a secondary designated hand selected from the player hand and the banker hand.

### Embodiment 5

The method of Embodiment 4, wherein: accepting from the player the primary wager designated for a primary outcome selected from a tie outcome and a hand win outcome comprises accepting from the player the primary wager designated for a primary outcome selected to be the hand win outcome to be based on the primary designated hand selected from the player hand and the banker hand; and accepting from the player the secondary wager designated for a secondary designated hand selected from the player hand and the banker hand comprises accepting from the player the secondary wager designated for a secondary designated hand selected to be a different hand of the player hand and the banker hand than the primary designated hand selected from the player hand and the banker hand.

### Embodiment 6

The method of Embodiment 3, wherein allocating a secondary payout in accordance with received instructions directing allocation of the secondary payout amongst the player, the primary wager, and the another primary wager comprises allocating the secondary payout amongst the primary wager designated for the primary outcome and another primary wager designated for another primary outcome selected from the tie outcome and another hand win outcome to be based on another primary designated hand selected from the player hand and the banker hand.

### Embodiment 7

The method of Embodiment 6, further comprising, before allocating the secondary payout amongst the primary wager designated for the primary outcome and the another primary wager designated for the another primary outcome, revealing at least one of the player hand and the banker hand as meeting a winning condition of the primary wagering game.

### Embodiment 8

The method of Embodiment 7, wherein resolving wagers on the primary wagering game based at least in part on dealt cards and in accordance with the primary game rules comprises awarding a primary payout based at least in part on the primary wager and the secondary payout.

### Embodiment 9

The method of any one of Embodiments 1 through 8, wherein resolving the secondary wager based at least in part on dealt cards and in accordance with the secondary game rules comprises: determining whether the dealt cards of a secondary designated hand selected from the player hand and the banker hand are of equal value to one another; and if determined that the dealt cards of the secondary designated hand are of equal value to one another, awarding the secondary payout.

### Embodiment 10

The method of Embodiment 9, wherein determining whether the dealt cards of a secondary designated hand selected from the player hand and the banker hand are of equal value to one another comprises determining whether the dealt cards are of equal value to one another based on poker ranking value.

### Embodiment 11

The method of Embodiment 9, wherein determining whether the dealt cards of a secondary designated hand selected from the player hand and the banker hand are of equal value to one another comprises determining whether a first two dealt cards of the secondary designated hand are of equal value to one another.

### Embodiment 12

The method of any one of Embodiments 1 through 11, wherein resolving wagers on the primary wagering game based at least in part on the dealt cards and in accordance with the primary game rules comprises resolving the wagers on the primary wagering game based at least in part on the dealt cards, additional cards dealt following allocating the secondary payout, and in accordance with the primary game rules.

### Embodiment 13

The method of Embodiment 1, wherein allocating a secondary payout in accordance with received instructions directing allocation of the secondary payout amongst an allocation group comprising the player, the primary wager, and another primary wager comprises allocating the secondary payout in accordance with received instructions directing allocation of the secondary payout amongst an allocation group comprising the player and another primary wager designating one of the player hand and the banker hand but not a tie outcome.

### Embodiment 14

A method of administering a wagering game, comprising: accepting from a player a primary wager on a game of baccarat to be performed in accordance with baccarat rules; accepting from the player a secondary wager on a side game to be performed in accordance with side game rules differing from the baccarat rules, the secondary wager designated to a secondary designated hand selected from a player hand and a banker hand; dealing two player cards to the player hand and two banker cards to the banker hand, such that the secondary designated hand comprises two designated cards; resolving the secondary wager, comprising: determining whether the two designated cards are of equal rank to one another; and if determined that the two designated cards are of equal rank to one another, awarding a secondary payout; if the secondary payout was awarded, allocating the secondary payout in accordance with instructions received from the player directing allocation of the secondary payout to at least one of an allocation group comprising the player, the primary wager, and another primary wager; and resolving wagers on the game of baccarat in accordance with the baccarat rules, wagers on the game of baccarat comprising the primary wager, secondary payout allocations to the primary wager, and secondary payout allocations to the another primary wager.

### Embodiment 15

The method of Embodiment 14, wherein, if determined that the two designated cards are of equal rank to one another, awarding a secondary payout comprises awarding a secondary payout of six times the secondary wager.

### Embodiment 16

The method of Embodiment 14, wherein allocating the secondary payout in accordance with instructions received from the player directing allocation of the secondary payout to at least one of an allocation group comprising the player, the primary wager, and another primary wager comprises: allocating a portion of the secondary payout to the player; limiting the instructions received from the player to instructions directing allocation of a remaining portion of the secondary payout; and allocating a remaining portion of the secondary payout in accordance with the instructions received from the player directing allocation of the secondary payout to at least one of the allocation group.

### Embodiment 17

The method of Embodiment 14, wherein accepting from a player a primary wager on a game of baccarat to be performed in accordance with baccarat rules comprises accepting from the player the primary wager on a game of three-card baccarat to be performed in accordance with three-card baccarat rules.

### Embodiment 18

A gaming table for administering a wagering game, comprising: a playing surface including at least one player interface; at least one dealer interface; and at least one processor programmed to: accept a primary wager on a game of baccarat to be performed in accordance with baccarat rules; accept a secondary wager on a side game to be performed in accordance with rules differing from the baccarat rules, the secondary wager designated to a designated hand selected from a player hand and a banker hand; resolve the secondary wager based at least on the designated hand; and allocate a secondary payout amongst a player, the primary wager, and another primary wager; and resolve wagers on the game of baccarat in accordance with the baccarat rules and based at least in part on the player hand and the banker hand, wagers on the game of baccarat comprising the primary wager, any allocation from the secondary wager toward the primary wager, and any allocation from the secondary wager toward the another primary wager.

### Embodiment 19

A system for administering a wagering game over a computer network, comprising: a game engine configured to be accessed by a client server over a network, the game engine being programmed to: accept an instruction from a client server to place a primary wager on a game of baccarat; accept an instruction from the client server to place a secondary wager on a side game using cards initially dealt to a player hand and a banker hand according to a set of game rules different from baccarat game rules; resolve the secondary wager according to the set of game rules, comprising: determining whether a winning condition has been met and, if so, awarding a secondary payout; accept an instruction from the client server to allocate the secondary payout amongst a player, the primary wager, and another primary wager; and resolve the primary wager according to the baccarat game rules.

### Embodiment 20

An electronic gaming machine for administering a wagering game, comprising: at least one player display and at least one player interface, wherein the at least one player interface enables a player to input a wager instruction; and at least one processor programmed to: accept from the at least one player interface a primary wager instruction for a game of baccarat; accept from the at least one player interface a secondary wager instruction for a side game; accept from the at least one player interface a secondary wager designation instruction identifying a secondary designated hand selected from a player hand and a banker hand; resolve a secondary wager of the secondary wager instruction according to a set of side game rules and based at least in part on the secondary designated hand, comprising: determining whether a winning condition has been met; and if determined that the winning condition has been met, determining a secondary payout; accept from the at least one player interface an allocation instruction to allocate the secondary payout among a player, a primary wager of the primary wager instruction, and another primary wager; allocate the secondary payout in accordance with the allocation instruction; and resolve wagers on the game of baccarat, wagers on the game of baccarat comprising the primary wager of the primary wager instruction, any allocation from the secondary payout toward the primary wager of the primary wager instruction, and any allocation from the secondary payout toward the another primary wager.

### Embodiment 21

The electronic gaming machine of Embodiment 20, wherein the at least one player display comprises a single player display configured for single player play of the wagering game.

### Embodiment 22

The electronic gaming machine of Embodiment 20, wherein the at least one player display comprises a common display configured for multi-player play of the wagering game.

While certain illustrative embodiments have been described in connection with the figures, those of ordinary skill in the art will recognize and appreciate that embodiments encompassed by the disclosure are not limited to those embodiments explicitly shown and described herein. Rather, many additions, deletions, and modifications to the embodiments described herein may be made without departing from the scope of embodiments encompassed by the disclosure, such as those hereinafter claimed, including legal equivalents. In addition, features from one disclosed embodiment may be combined with features of another disclosed embodiment while still being within the scope of the disclosure, as contemplated by the inventor.

What is claimed is:

1. A method of administering a wagering game, comprising:
accepting from a player a primary wager on a primary wagering game to be performed in accordance with primary game rules;
accepting from the player a secondary wager on a secondary wagering game to be performed in accordance with secondary game rules;
dealing cards to a player hand and to a banker hand;
resolving the secondary wager based at least in part on dealt cards and in accordance with the secondary game rules;
for winning outcomes on the secondary wager, allocating a secondary payout in accordance with received instructions directing allocation of the secondary payout amongst an allocation group comprising the player, the primary wager, and another primary wager; and
resolving wagers on the primary wagering game based at least in part on the dealt cards and in accordance with the primary game rules, comprising:
resolving the primary wager including any allocation from the secondary payout allocated toward the primary wager; and
resolving any other allocation from the secondary payout allocated toward the another primary wager.

2. The method of claim 1, wherein allocating a secondary payout in accordance with received instructions directing allocation of the secondary payout amongst an allocation group comprising the player, the primary wager, and the another primary wager comprises:
allocating a portion of the secondary payout to one of the allocation group; and
allocating another portion of the secondary payout to another of the allocation group.

3. The method of claim 1, wherein accepting from a player a primary wager on a primary wagering game to be performed in accordance with primary game rules comprises accepting from the player the primary wager designated for a primary outcome selected from a tie outcome and a hand win outcome, the tie outcome to be based on both the player hand and the banker hand, and the hand win outcome to be based on a primary designated hand selected from the player hand and the banker hand.

4. The method of claim 3, wherein accepting from the player a secondary wager on a secondary wagering game to be performed in accordance with secondary game rules comprises accepting from the player the secondary wager designated for a secondary designated hand selected from the player hand and the banker hand.

5. The method of claim 4, wherein:
accepting from the player the primary wager designated for a primary outcome selected from a tie outcome and a hand win outcome comprises accepting from the player the primary wager designated for a primary outcome selected to be the hand win outcome to be based on the primary designated hand selected from the player hand and the banker hand; and
accepting from the player the secondary wager designated for a secondary designated hand selected from the player hand and the banker hand comprises accepting from the player the secondary wager designated for a secondary designated hand selected to be a different hand of the player hand and the banker hand than the primary designated hand selected from the player hand and the banker hand.

6. The method of claim 3, wherein allocating a secondary payout in accordance with received instructions directing allocation of the secondary payout amongst the player, the primary wager, and the another primary wager comprises allocating the secondary payout amongst the primary wager designated for the primary outcome and another primary wager designated for another primary outcome selected from the tie outcome and another hand win outcome to be based on another primary designated hand selected from the player hand and the banker hand.

7. The method of claim 6, further comprising, before allocating the secondary payout amongst the primary wager designated for the primary outcome and the another primary wager designated for the another primary outcome, revealing at least one of the player hand and the banker hand as meeting a winning condition of the primary wagering game.

8. The method of claim 7, wherein resolving wagers on the primary wagering game based at least in part on dealt cards and in accordance with the primary game rules comprises awarding a primary payout based at least in part on the primary wager and the secondary payout.

9. The method of claim 1, wherein resolving the secondary wager based at least in part on dealt cards and in accordance with the secondary game rules comprises:
determining whether the dealt cards of a secondary designated hand selected from the player hand and the banker hand are of equal value to one another; and
if determined that the dealt cards of the secondary designated hand are of equal value to one another, awarding the secondary payout.

10. The method of claim 9, wherein determining whether the dealt cards of a secondary designated hand selected from the player hand and the banker hand are of equal value to one another comprises determining whether the dealt cards are of equal value to one another based on poker ranking value.

11. The method of claim 9, wherein determining whether the dealt cards of a secondary designated hand selected from the player hand and the banker hand are of equal value to one another comprises determining whether a first two dealt cards of the secondary designated hand are of equal value to one another.

12. The method of claim 1, wherein resolving wagers on the primary wagering game based at least in part on the dealt cards and in accordance with the primary game rules comprises resolving the wagers on the primary wagering game based at least in part on the dealt cards, additional cards dealt following allocating the secondary payout, and in accordance with the primary game rules.

13. The method of claim 1, wherein allocating a secondary payout in accordance with received instructions directing allocation of the secondary payout amongst an allocation group comprising the player, the primary wager, and another primary wager comprises allocating the secondary payout in accordance with received instructions directing allocation of the secondary payout amongst an allocation group comprising the player and another primary wager designating one of the player hand and the banker hand but not a tie outcome.

14. A method of administering a wagering game, comprising:
accepting from a player a primary wager on a game of baccarat to be performed in accordance with baccarat rules;
accepting from the player a secondary wager on a side game to be performed in accordance with side game rules differing from the baccarat rules, the secondary wager designated to a secondary designated hand selected from a player hand and a banker hand;
dealing two player cards to the player hand and two banker cards to the banker hand, such that the secondary designated hand comprises two designated cards;
resolving the secondary wager, comprising:
determining whether the two designated cards are of equal rank to one another; and
if determined that the two designated cards are of equal rank to one another, awarding a secondary payout;
if the secondary payout was awarded, allocating the secondary payout in accordance with instructions received from the player directing allocation of the secondary payout to at least one of an allocation group comprising the player, the primary wager, and another primary wager; and
resolving wagers on the game of baccarat in accordance with the baccarat rules, wagers on the game of baccarat comprising the primary wager, secondary payout allocations to the primary wager, and secondary payout allocations to the another primary wager.

15. The method of claim 14, wherein, if determined that the two designated cards are of equal rank to one another, awarding a secondary payout comprises awarding a secondary payout of six times the secondary wager.

16. The method of claim 14, wherein allocating the secondary payout in accordance with instructions received from the player directing allocation of the secondary payout to at least one of an allocation group comprising the player, the primary wager, and another primary wager comprises:
allocating a portion of the secondary payout to the player;
limiting the instructions received from the player to instructions directing allocation of a remaining portion of the secondary payout; and
allocating a remaining portion of the secondary payout in accordance with the instructions received from the player directing allocation of the secondary payout to at least one of the allocation group.

17. The method of claim 14, wherein accepting from a player a primary wager on a game of baccarat to be performed in accordance with baccarat rules comprises accepting from the player the primary wager on a game of three-card baccarat to be performed in accordance with three-card baccarat rules.

18. A gaming table for administering a wagering game, comprising:
a playing surface including at least one player interface;
at least one dealer interface; and
at least one processor programmed to:
accept a primary wager on a game of baccarat to be performed in accordance with baccarat rules;
accept a secondary wager on a side game to be performed in accordance with rules differing from the baccarat rules, the secondary wager designated to a designated hand selected from a player hand and a banker hand;
resolve the secondary wager based at least on the designated hand; and
allocate a secondary payout amongst a player, the primary wager, and another primary wager; and
resolve wagers on the game of baccarat in accordance with the baccarat rules and based at least in part on the player hand and the banker hand, wagers on the game of baccarat comprising the primary wager, any allocation from the secondary wager toward the primary wager, and any allocation from the secondary wager toward the another primary wager.

19. A system for administering a wagering game over a computer network, comprising:
a game engine configured to be accessed by a client server over a network, the game engine being programmed to:
accept an instruction from a client server to place a primary wager on a game of baccarat;
accept an instruction from the client server to place a secondary wager on a side game using cards initially dealt to a player hand and a banker hand according to a set of game rules different from baccarat game rules;
resolve the secondary wager according to the set of game rules, comprising:
determining whether a winning condition has been met and, if so, awarding a secondary payout;
accept an instruction from the client server to allocate the secondary payout amongst a player, the primary wager, and another primary wager; and
resolve the primary wager according to the baccarat game rules.

20. An electronic gaming machine for administering a wagering game, comprising:
at least one player display and at least one player interface, wherein the at least one player interface enables a player to input a wager instruction; and
at least one processor programmed to:
accept from the at least one player interface a primary wager instruction for a game of baccarat;
accept from the at least one player interface a secondary wager instruction for a side game;
accept from the at least one player interface a secondary wager designation instruction identifying a secondary designated hand selected from a player hand and a banker hand;
resolve a secondary wager of the secondary wager instruction according to a set of side game rules and based at least in part on the secondary designated hand, comprising:
determining whether a winning condition has been met; and
if determined that the winning condition has been met, determining a secondary payout;
accept from the at least one player interface an allocation instruction to allocate the secondary payout among a player, a primary wager of the primary wager instruction, and another primary wager;
allocate the secondary payout in accordance with the allocation instruction; and
resolve wagers on the game of baccarat, wagers on the game of baccarat comprising the primary wager of the primary wager instruction, any allocation from the secondary payout toward the primary wager of the primary wager instruction, and any allocation from the secondary payout toward the another primary wager.

21. The electronic gaming machine of claim 20, wherein the at least one player display comprises a single player display configured for single player play of the wagering game.

22. The electronic gaming machine of claim 20, wherein the at least one player display comprises a common display configured for multi-player play of the wagering game.
